(19) United States
(12) Patent Application Publication
(10) Pub. No.: US 2014/0184761 A1
(43) Pub. Date: Jul. 3, 2014

(54) Displaying an Auto-Stereoscopic Image

(71) Applicant: Stephen Gunnar Keen, Tampere (FI)

(72) Inventor: Stephen Gunnar Keen, Tampere (FI)

(73) Assignee: Nokia Corporation, Espoo (FI)

(21) Appl. No.: 13/996,591

(22) PCT Filed: Dec. 23, 2010
(86) PCT No.: PCT/IB2010/056062

§ 371 Date: Feb. 14, 2014

(51) Int. Cl. H04N 13/04

(52) U.S. Cl. CPC H04N 13/0409; H04N 13/0497
USPC 348/54

(57) ABSTRACT

An apparatus, a method and a computer program are provided. The apparatus may include: a display panel including a plurality of pixel groups, wherein each pixel group includes first, second, third and fourth pixels; and an optical arrangement configured, when the display panel is in a first orientation relative to a viewer, to use the first and second pixels in each pixel group to provide a first image of an auto-stereoscopic image and to use the third and fourth pixels in each pixel group to provide a second image of the auto-stereoscopic image, and wherein the optical arrangement is configured, when the display panel is in a second orientation relative to the viewer, to use the first and third pixels in each pixel group to provide a first image of a further auto-stereoscopic image and to use the second and fourth pixels in each pixel group to provide a second image of the further auto-stereoscopic image.

### TECHNOLOGICAL FIELD

Embodiments of the present invention relate to displaying an auto-stereoscopic image. In particular, they relate to displaying an auto-stereoscopic image when a display panel has a first orientation (for example, portrait) and displaying an auto-stereoscopic image when the display panel has a second orientation (for example, landscape).

### BACKGROUND

A stereoscopic display apparatus provides a viewer with the perception that he is viewing a three dimensional image by presenting a slightly different image to each of the viewer's eyes.

Some stereoscopic display apparatuses require a user to wear specialized glasses to obtain a stereoscopic sensation. Auto-stereoscopic display apparatuses, however, do not require the use of these specialized glasses. An auto-stereoscopic display apparatus is arranged to direct different images towards each of the viewer's eyes to provide a stereoscopic sensation.

### BRIEF SUMMARY

According to some, but not necessarily all, embodiments of the invention, there is provided an apparatus, comprising: a display panel comprising a plurality of pixel groups, wherein each pixel group comprises first, second, third and fourth pixels; and an optical arrangement configured, when the display panel is in a first orientation relative to a viewer, to use the first and second pixels in each pixel group to provide a first image of an auto-stereoscopic image and to use the third and fourth pixels in each pixel group to provide a second image of the auto-stereoscopic image, and wherein the optical arrangement is configured, when the display panel is in a second orientation relative to the viewer, to use the first and third pixels in each pixel group to provide a first image of a further auto-stereoscopic image and to use the second and fourth pixels in each pixel group to provide a second image of the further auto-stereoscopic image.

According to some, but not necessarily all, embodiments of the invention, there is provided an apparatus, comprising: at least one memory storing a computer program comprising computer program instructions; and at least one processor configured to execute the computer program instructions to cause the apparatus at least to perform: controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and controlling, when the display panel is in a second orientation, the first and third pixels in each pixel group to display a first image of a further auto-stereoscopic image and the second and fourth pixels in each pixel group to display a second image of the further auto-stereoscopic image.

According to some, but not necessarily all, embodiments of the invention, there is provided a method, comprising: controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and controlling, when the display panel is in a second orientation, the first and third pixels in each pixel group to display a first image of a further auto-stereoscopic image and the second and fourth pixels in each pixel group to display a second image of the further auto-stereoscopic image.

According to some, but not necessarily all, embodiments of the invention, there is provided a computer program comprising computer program instructions that, when executed by at least one processor, cause at least the following to be performed: controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and controlling, when the display panel is in a second orientation, the first and third pixels in each pixel group to display a first image of a further auto-stereoscopic image and the second and fourth pixels in each pixel group to display a second image of the further auto-stereoscopic image.

According to some, but not necessarily all, embodiments of the invention, there is provided an apparatus, comprising: a display panel comprising an array of pixels, the array comprising at least first and second columns and at least first and second rows, wherein the columns are substantially perpendicular to the rows; an optical arrangement configured, when the display panel is in a first orientation relative to a viewer, to use at least the first column of pixels to provide a first image of an auto-stereoscopic image and to use at least the second column of pixels to provide a second image of the auto-stereoscopic image, and wherein the optical arrangement is configured, when the display panel is in a second orientation relative to the viewer, to use at least the first row of pixels to provide a first image of a further auto-stereoscopic image and to use at least the second row of pixels to provide a second image of the further auto-stereoscopic image.

According to some, but not necessarily all, embodiments of the invention, there is provided an apparatus, comprising: a display panel comprising a plurality of pixels; and at least one holographic optical device configured to use the plurality of pixels to provide an auto-stereoscopic image.

### BRIEF DESCRIPTION

For a better understanding of various examples of embodiments of the present invention reference will now be made by way of example only to the accompanying drawings in which:

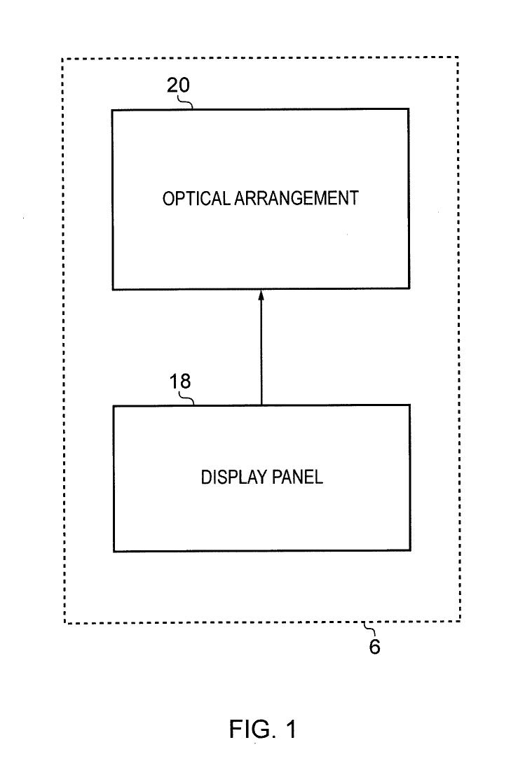

FIG. 1 illustrates a display apparatus;

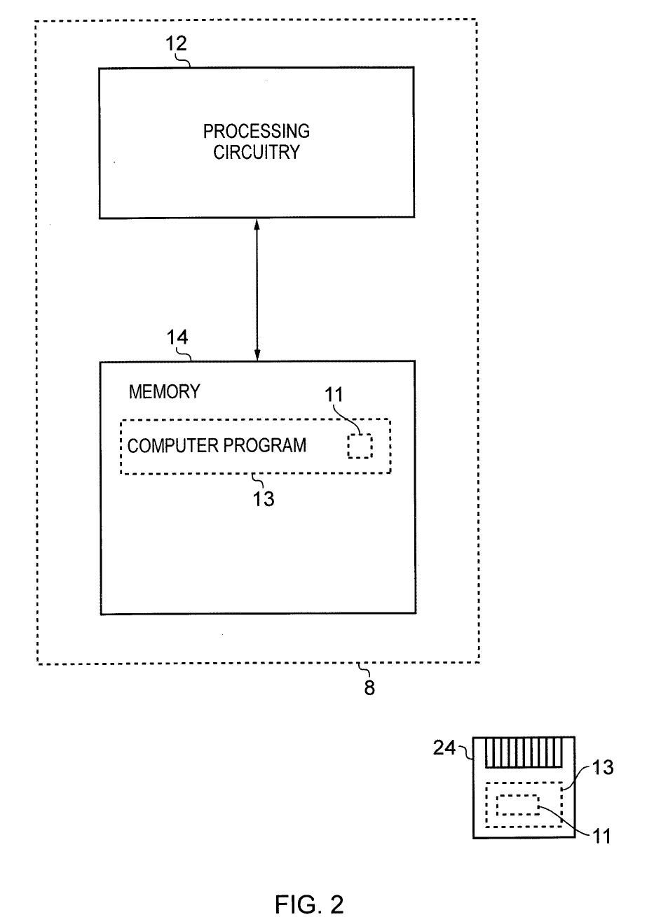

FIG. 2 illustrates a control apparatus;

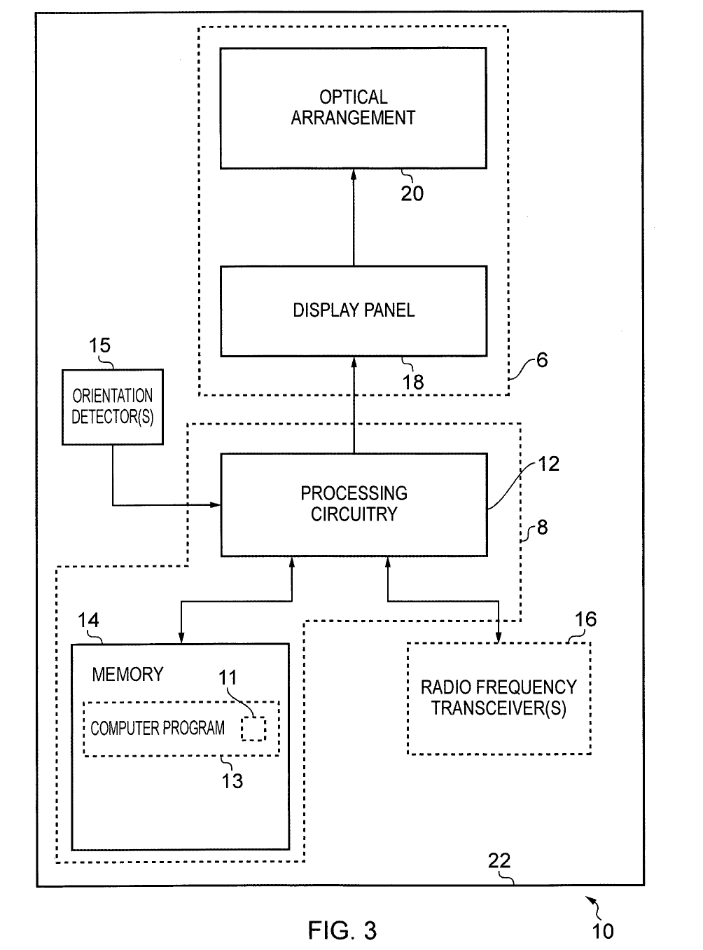

FIG. 3 illustrates an electronic apparatus;

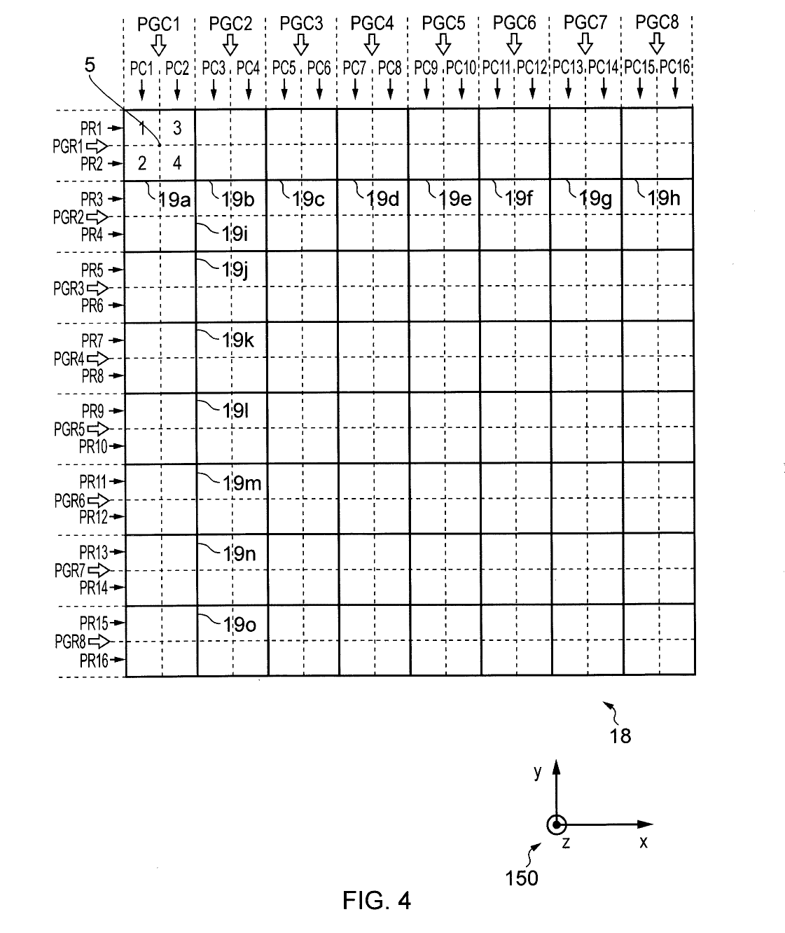

FIG. 4 illustrates a portion of a display panel;

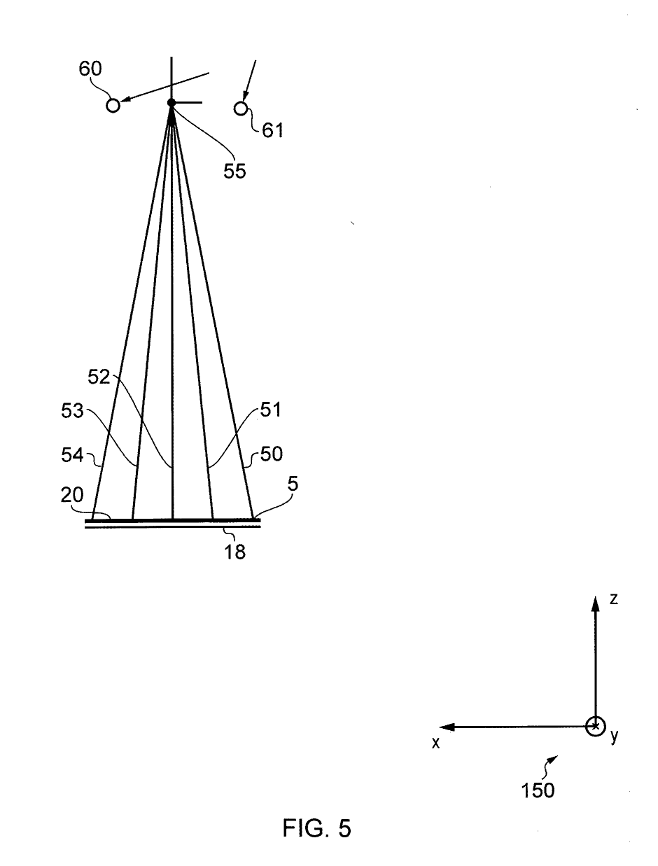

FIG. 5 illustrates a schematic of various optical axes of an optical arrangement;

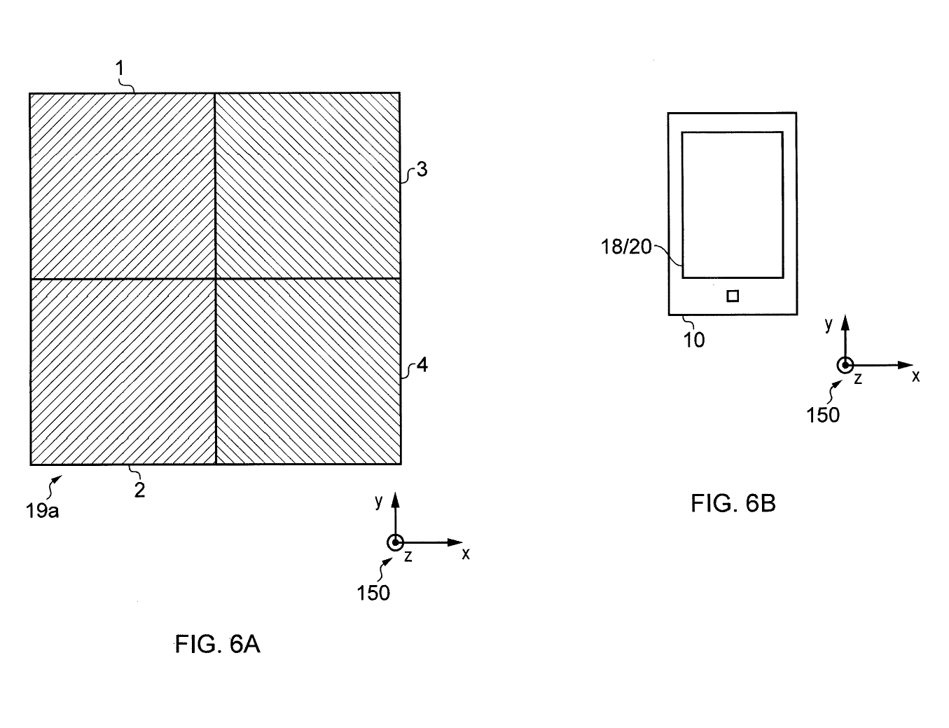

FIG. 6A illustrates a pixel control technique for displaying an auto-stereoscopic image when the display panel is in a first orientation;

FIG. 6B illustrates an electronic apparatus in the first orientation;

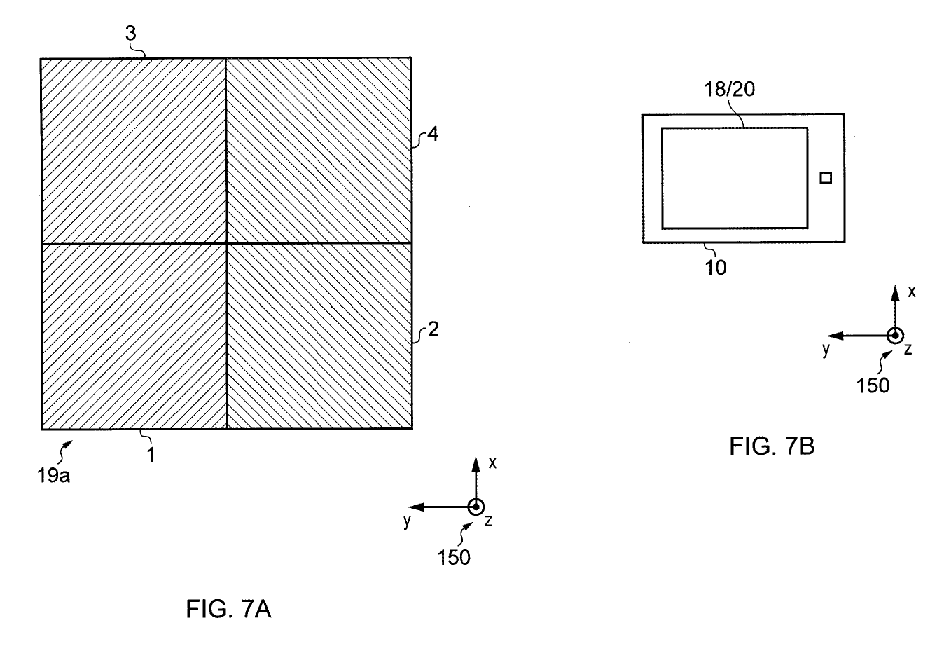

FIG. 7A illustrates a pixel control technique for displaying an auto-stereoscopic image when the display panel is in a second orientation;

FIG. 7B illustrates an electronic apparatus in the second orientation;

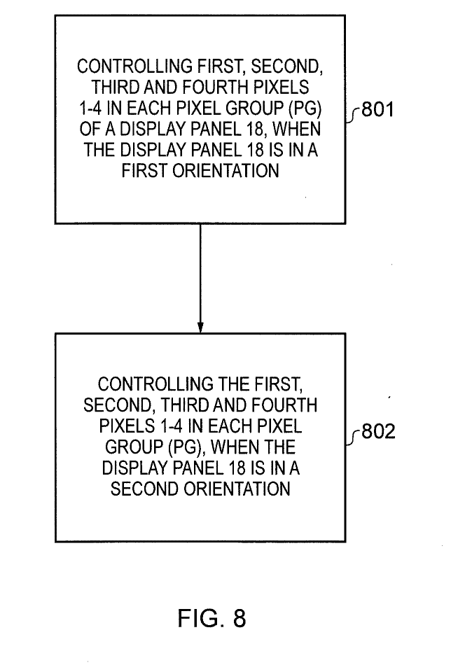

FIG. 8 illustrates a flow chart of a method;

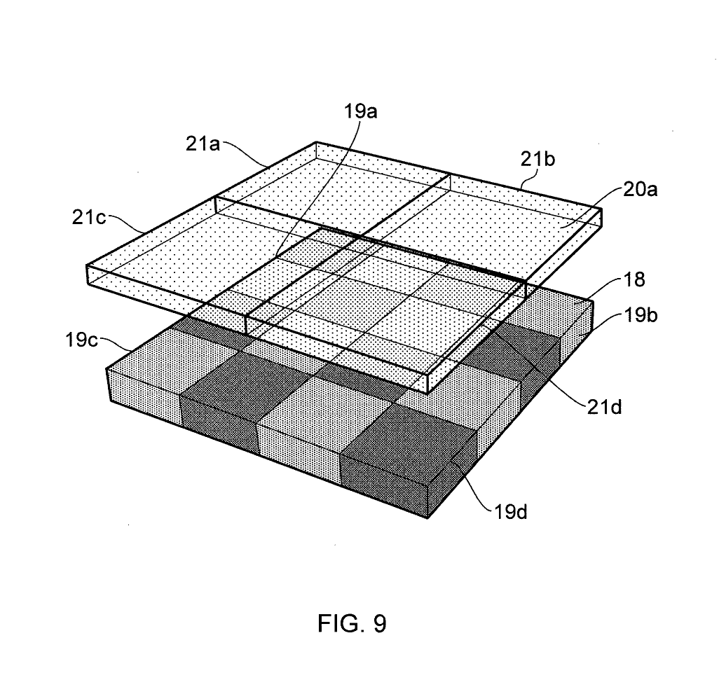

FIG. 9 illustrates a portion of a first embodiment of the optical arrangement and a portion of the display panel;

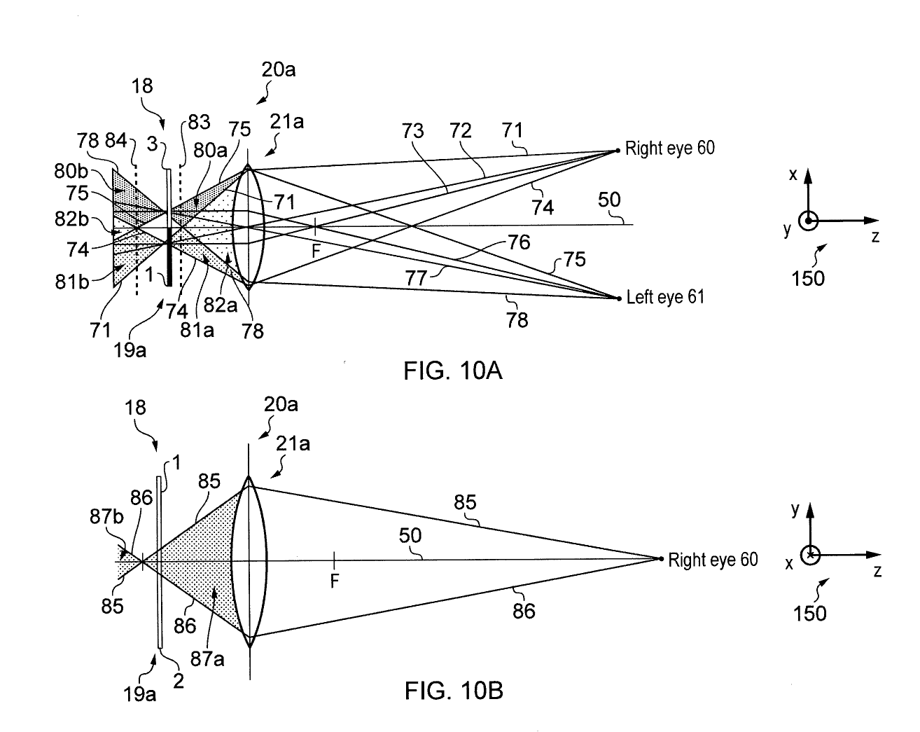

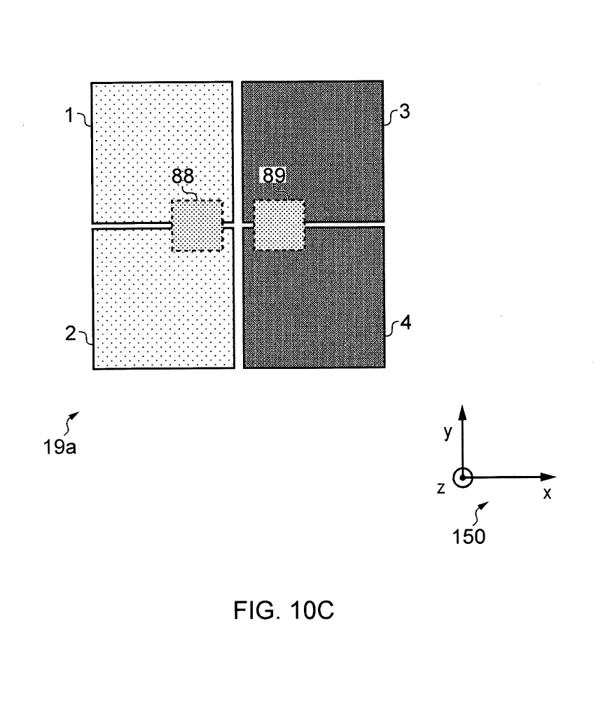

FIG. 10A illustrates, for a first orientation of the display panel, a plan view of a ray diagram that includes the first embodiment of the optical arrangement and the display panel;

FIG. 10B illustrates, for the first orientation of the display panel, a side view of a ray diagram that includes the first embodiment of the optical arrangement and the display panel;

FIG. 10C illustrates the areas of a pixel group that are viewed by a viewer, when using the first embodiment of the optical arrangement and when viewing an auto-stereoscopic image in the first orientation;

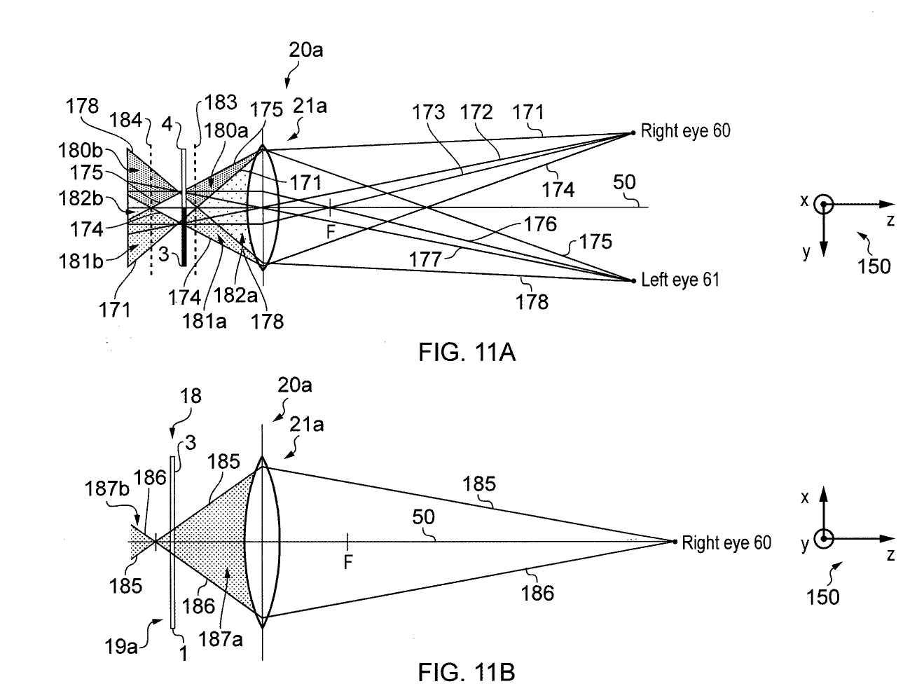

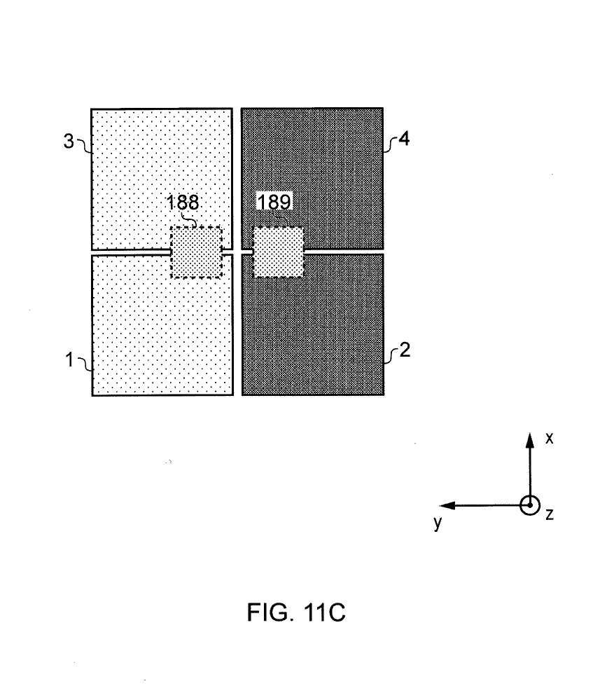

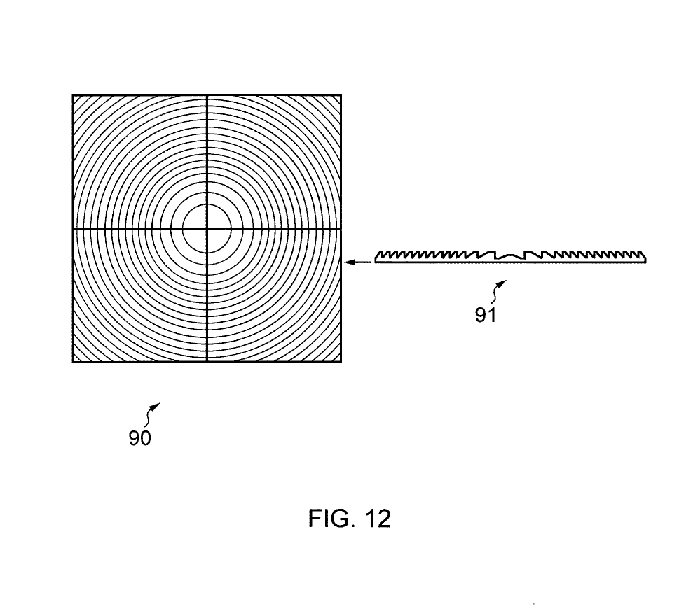

FIG. 11A illustrates, for a second orientation of the display panel, a plan view of a ray diagram that includes the first embodiment of the optical arrangement and the display panel;

FIG. 11B illustrates, for the second orientation of the display panel, a side view of a ray diagram that includes the first embodiment of the optical arrangement and the display panel;

FIG. 11C illustrates the areas of a pixel group that are viewed by a viewer, when using the first embodiment of the optical arrangement when viewing an auto-stereoscopic image in the second orientation;

FIG. 12 illustrates a plan view and a cross-sectional view of a Fresnel lens for use in the first embodiment of the optical arrangement;

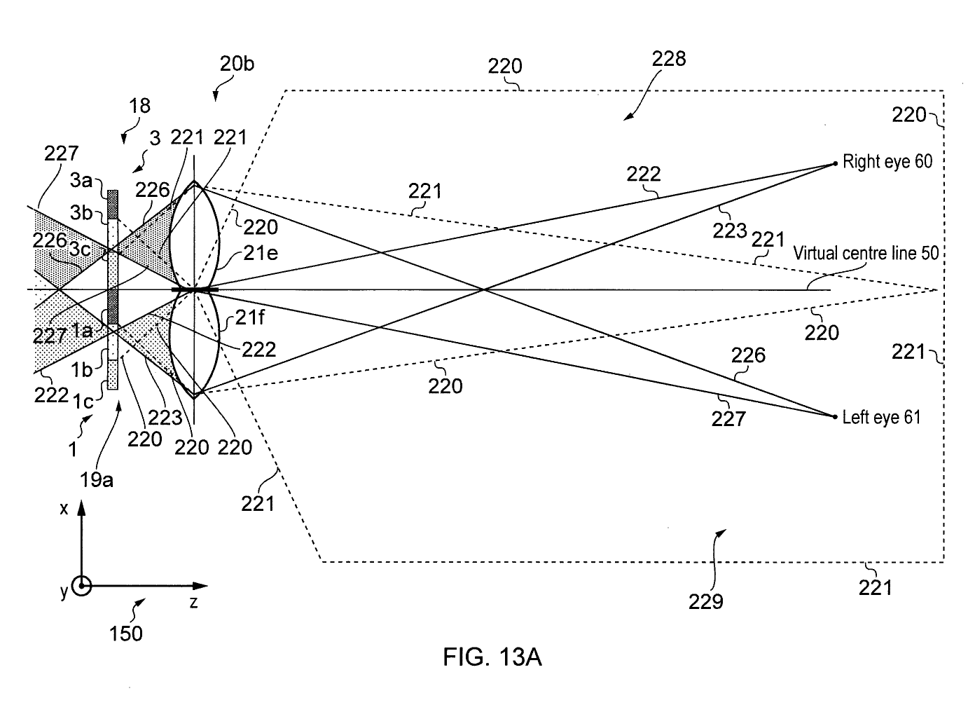

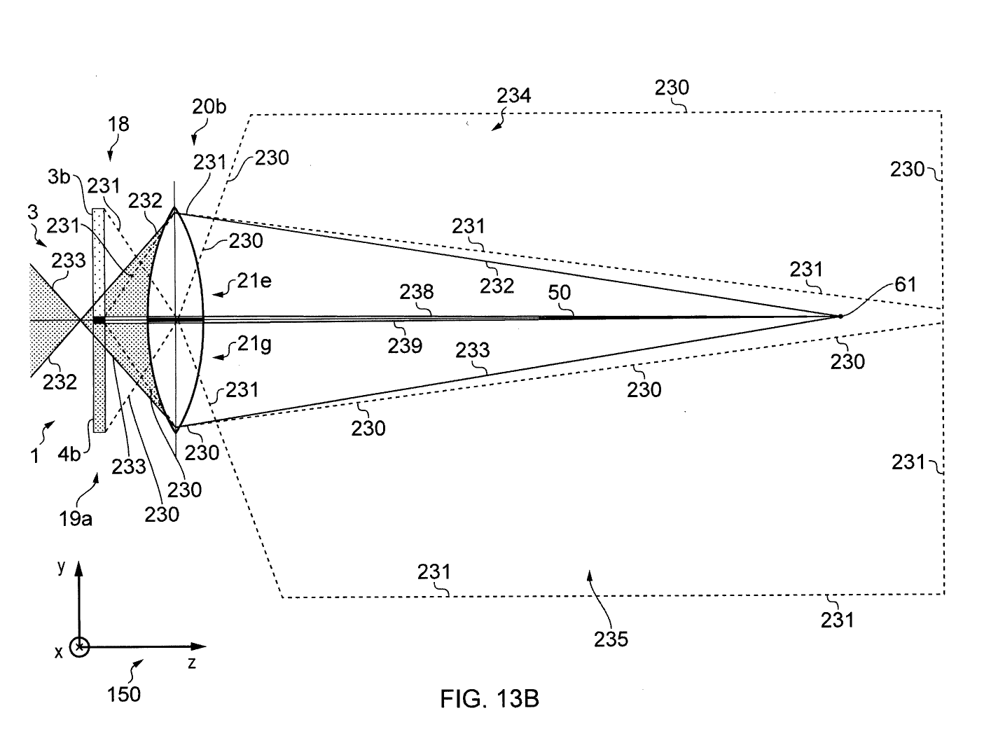

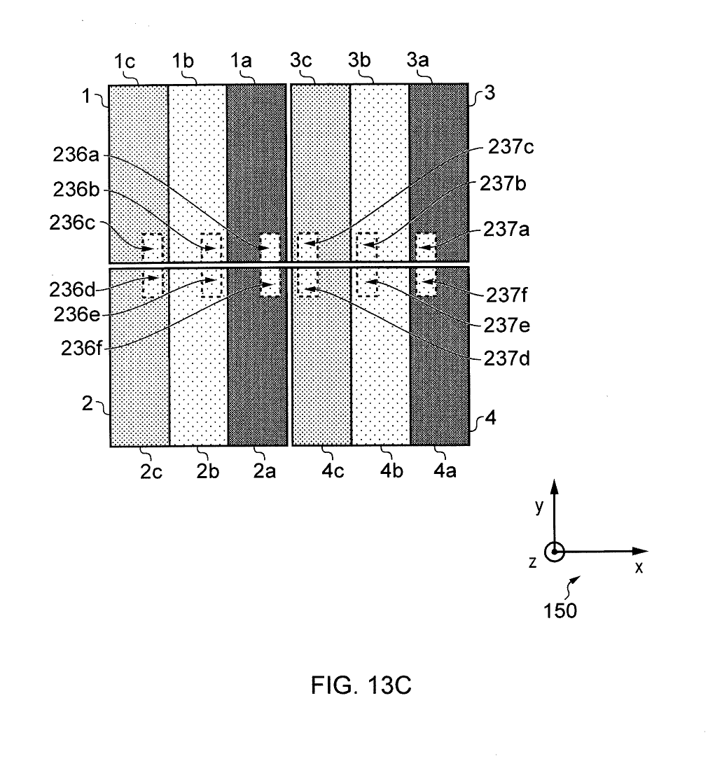

FIG. 13A illustrates, for a first orientation of the display panel, a plan view of a ray diagram that includes the second embodiment of the optical arrangement and the display panel;

FIG. 13B illustrates, for the first orientation of the display panel, a side view of a ray diagram that includes the second embodiment of the optical arrangement and the display panel;

FIG. 13C illustrates the areas of a pixel group that are viewed by a viewer, when using the second embodiment of the optical arrangement and when viewing an auto-stereoscopic image in the first orientation;

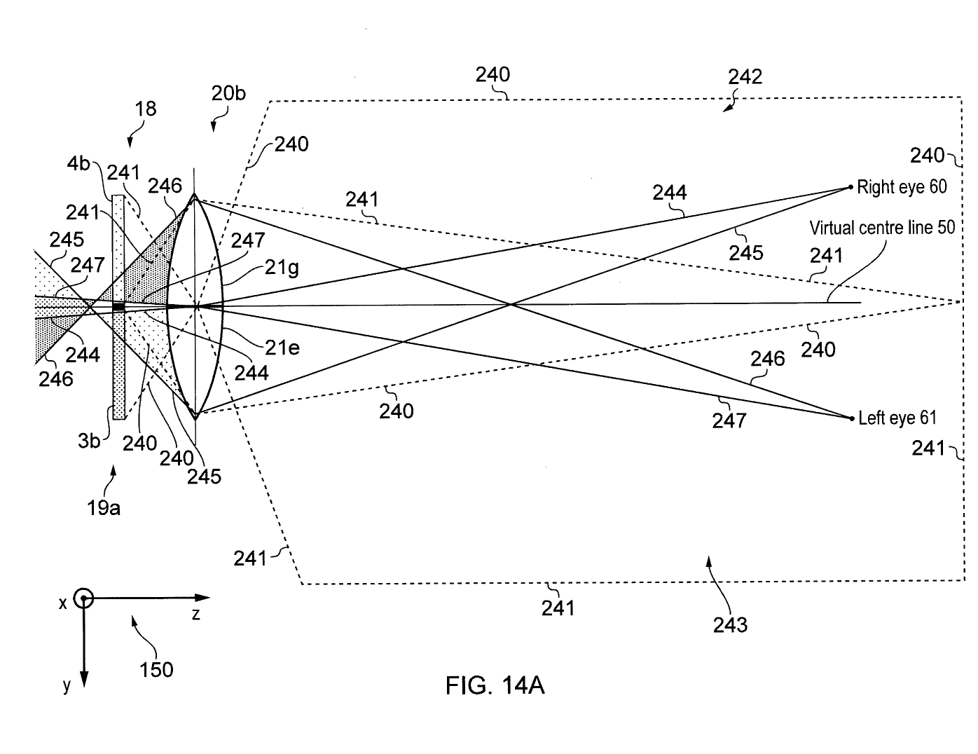

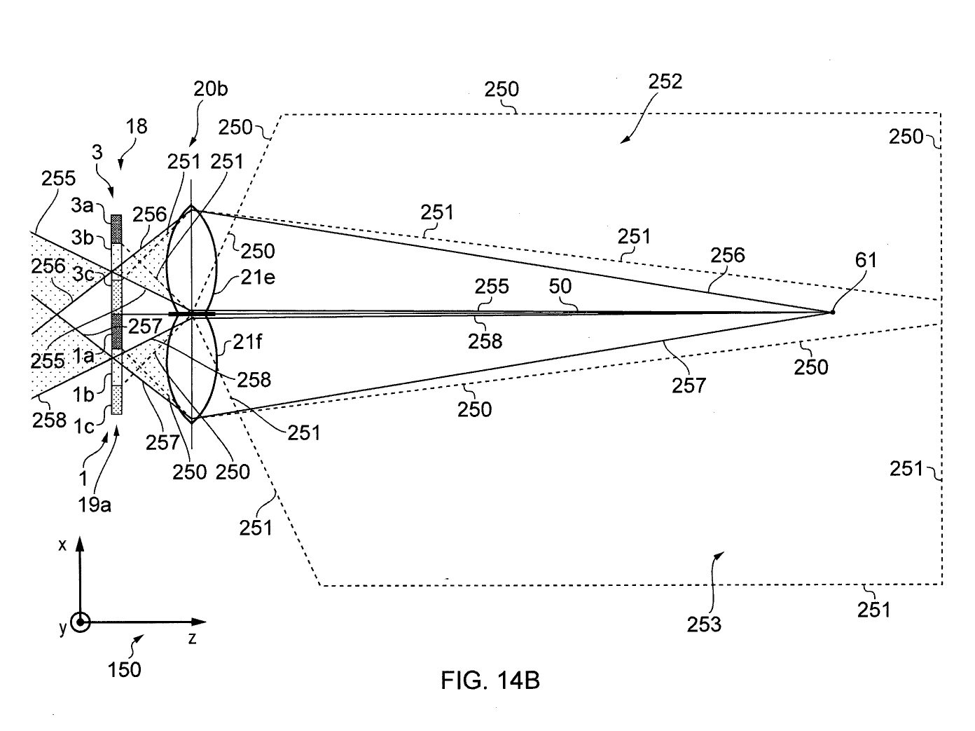

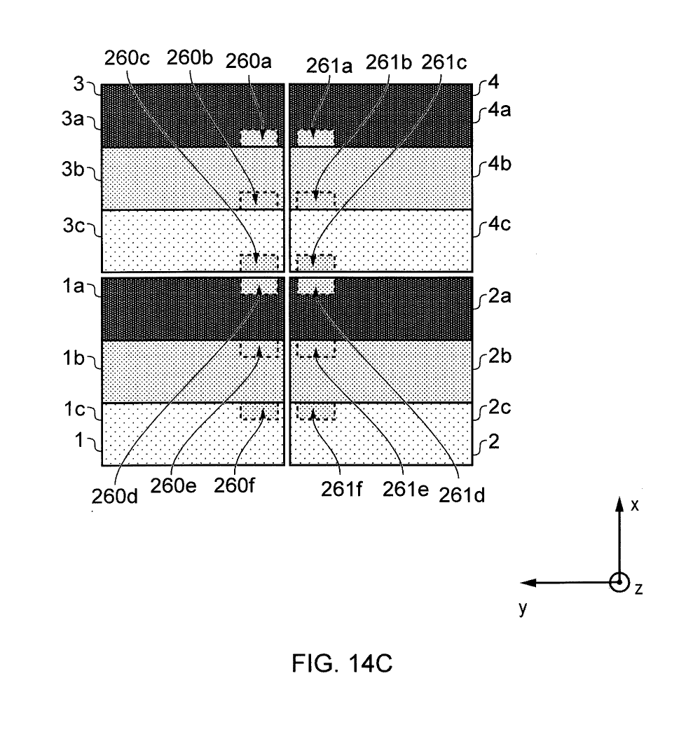

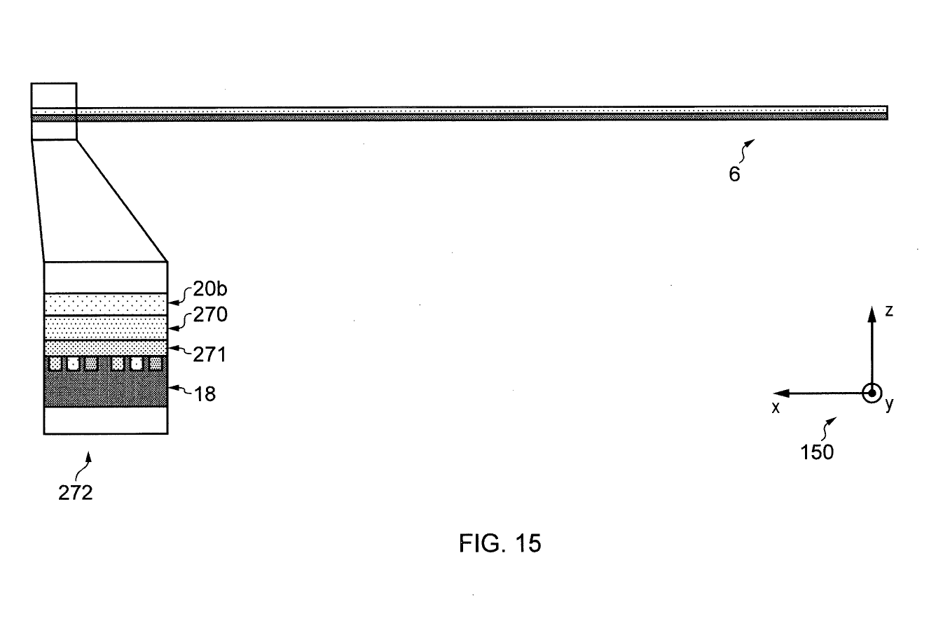

FIG. 14A illustrates, for a second orientation of the display panel, a plan view of a ray diagram that includes the second embodiment of the optical arrangement and the display panel;

FIG. 14B illustrates, for the second orientation of the display panel, a side view of a ray diagram that includes the second embodiment of the optical arrangement and the display panel;

FIG. 14C illustrates the areas of a pixel group that are viewed by a viewer, when using the second embodiment of the optical arrangement and when viewing an auto-stereoscopic image in the second orientation;

FIG. 15 illustrates a cross section of a switchable display apparatus;

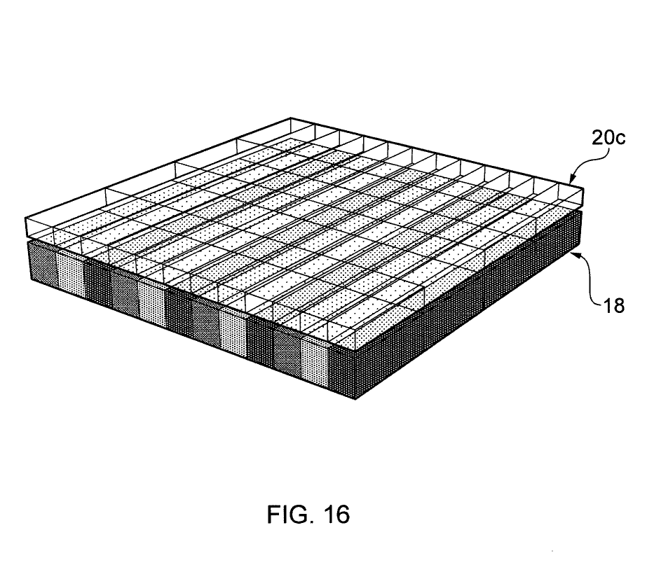

FIG. 16 illustrates a portion of a third embodiment of the optical arrangement and a portion of the display panel;

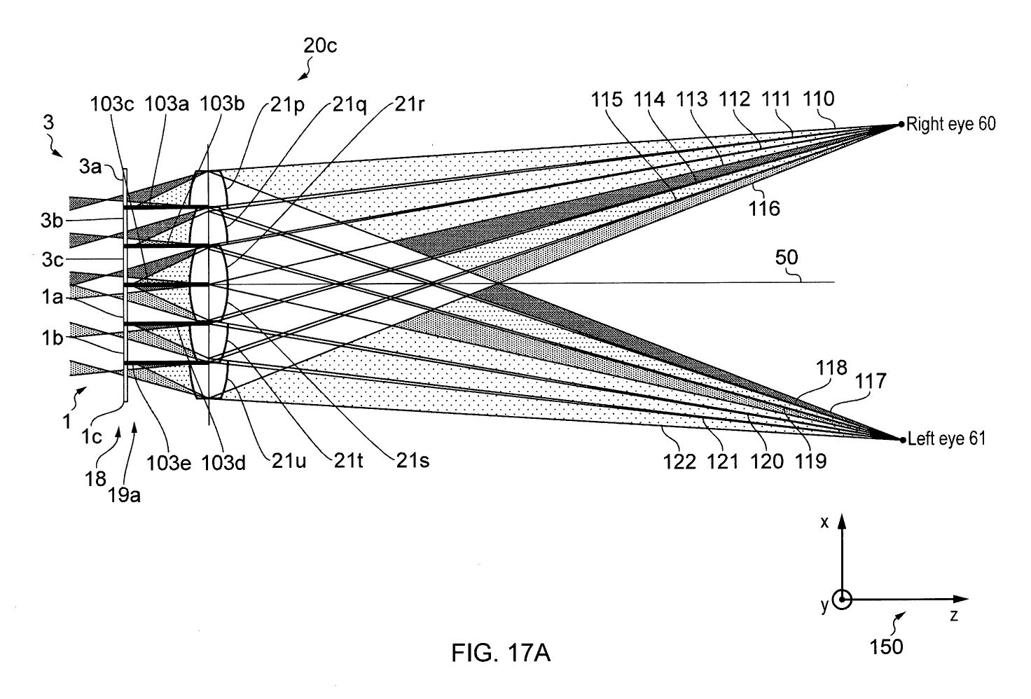

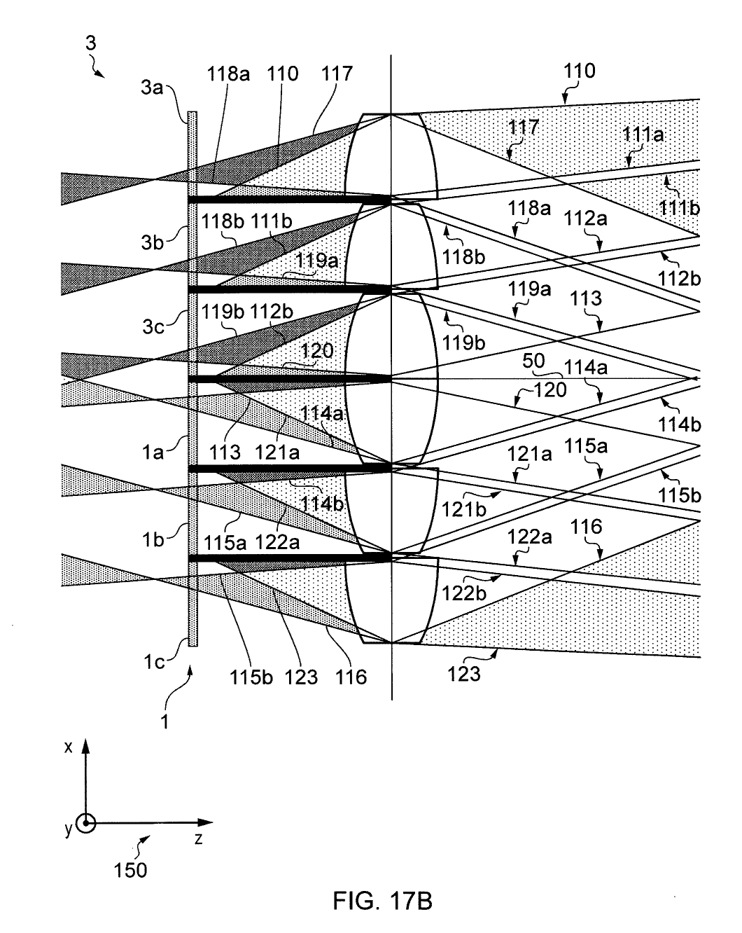

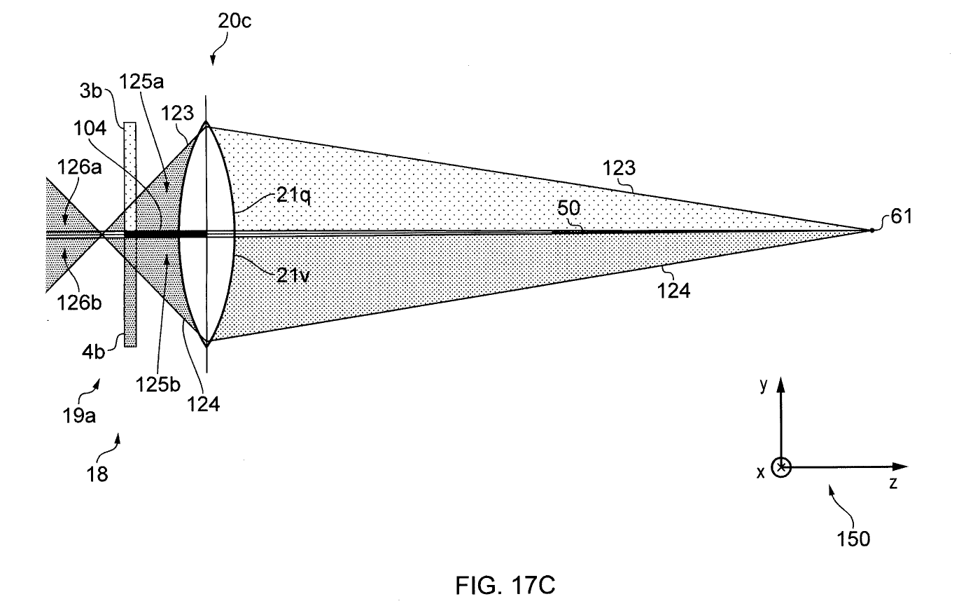

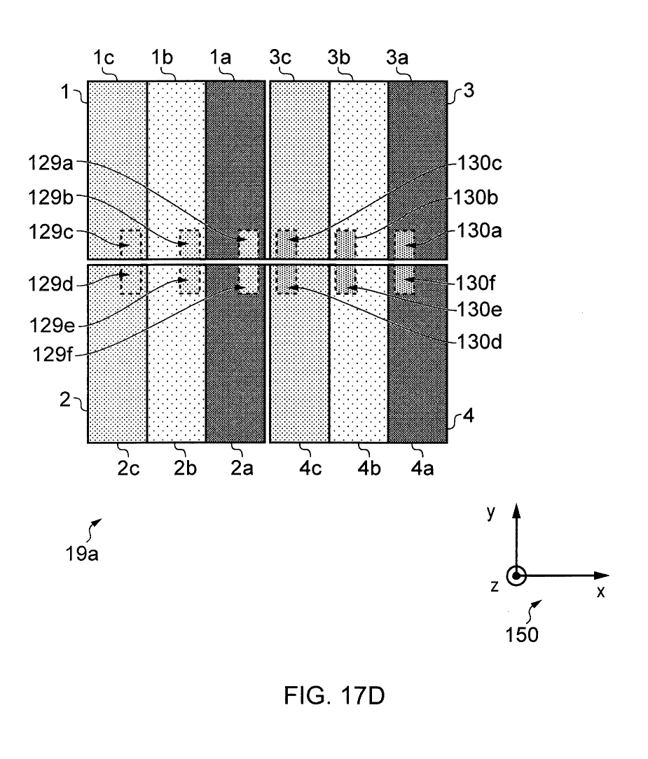

FIG. 17A illustrates, for a first orientation of the display panel, a plan view of a ray diagram that includes the third embodiment of the optical arrangement and the display panel;

FIG. 17B illustrates a magnified portion of FIG. 17A;

FIG. 17C illustrates, for the first orientation of the display panel, a side view of a ray diagram that includes the third embodiment of the optical arrangement and the display panel;

FIG. 17D illustrates the areas of a pixel group that are viewed by a viewer, when using the third embodiment of the optical arrangement and when viewing an auto-stereoscopic image in the first orientation;

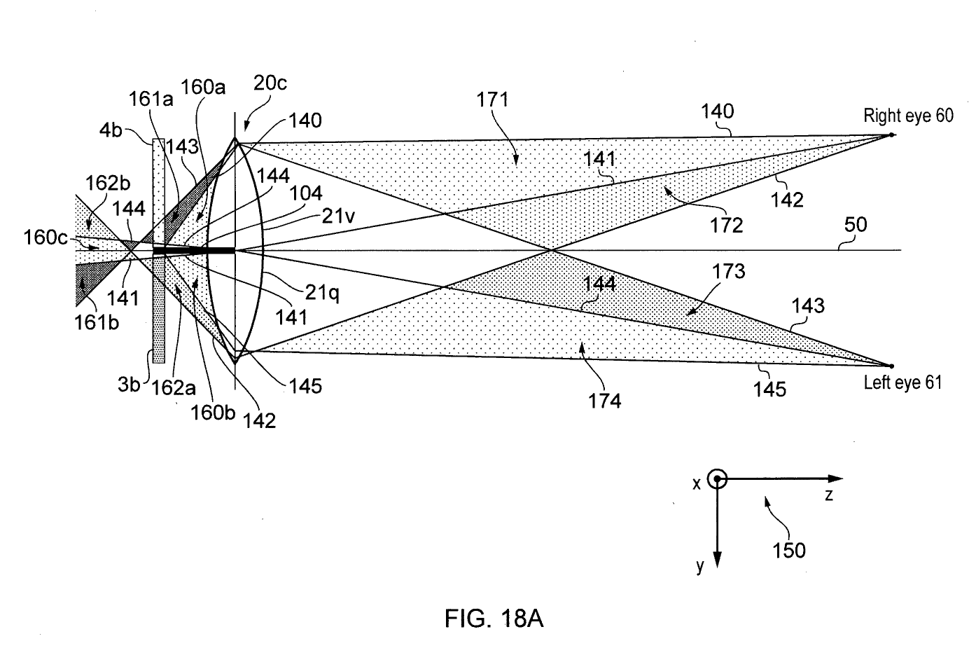

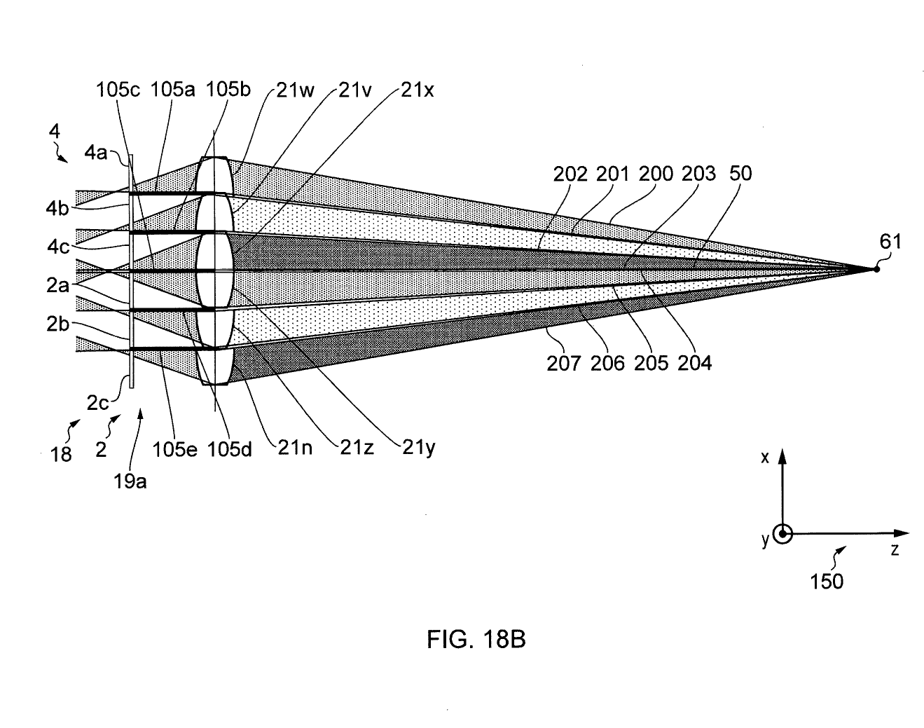

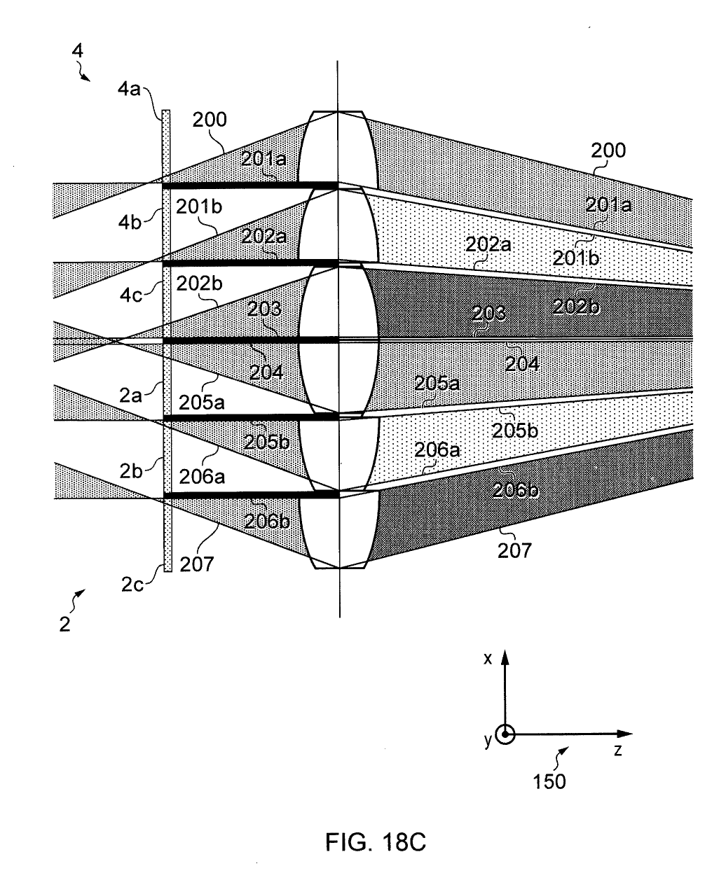

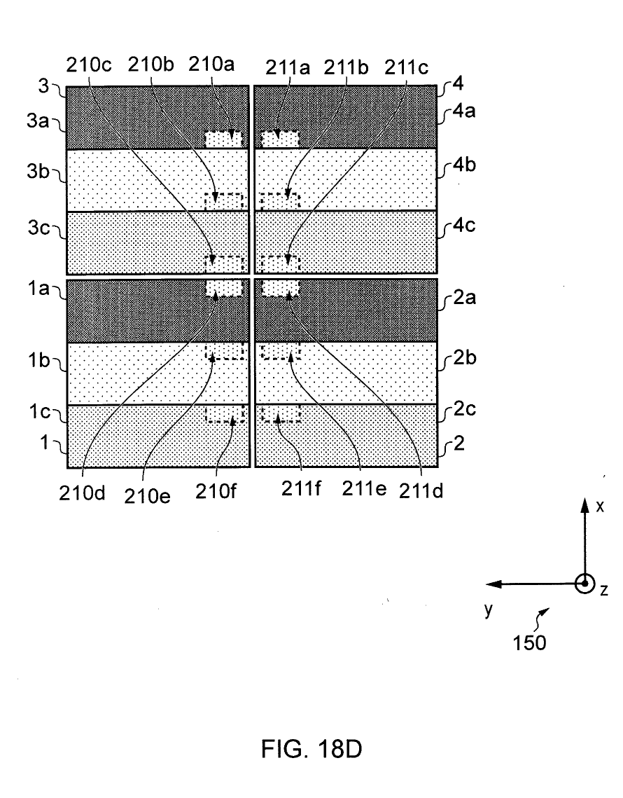

FIG. 18A illustrates, for a second orientation of the display panel, a plan view of a ray diagram that includes the third embodiment of the optical arrangement and the display panel;

FIG. 18B illustrates, for the second orientation of the display panel, a side view of a ray diagram that includes the third embodiment of the optical arrangement and the display panel;

FIG. 18C illustrates a magnified portion of FIG. 18B;

FIG. 18D illustrates the areas of a pixel group that are viewed by a viewer, when using the third embodiment of the optical arrangement and when viewing an auto-stereoscopic image in the second orientation; and

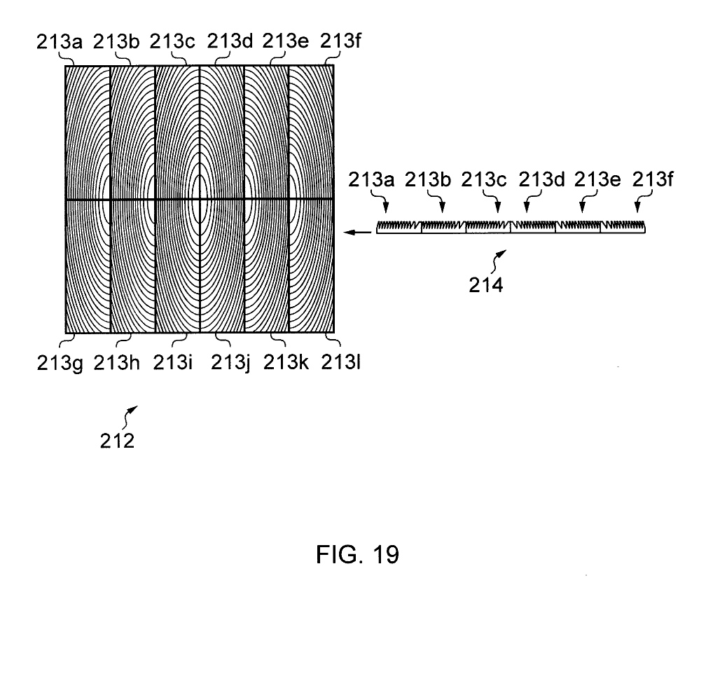

FIG. 19 illustrates a plan view and a cross-sectional view of a Fresnel lens for use in the third embodiment of the optical arrangement.

### DETAILED DESCRIPTION

Embodiments of the invention relate to enabling auto-stereoscopic images to be viewed when a display panel is in a first orientation (for example, portrait), and when the display panel is in a second orientation (for example, landscape).

FIG. 1 illustrates a display apparatus 6 comprising a display panel 18 and an optical arrangement 20. The display panel 18 comprises an array of pixels arranged in columns and rows, where the rows are substantially perpendicular to the columns. The display panel 18 may be any type of display panel including, for example, a liquid crystal display (LCD) panel, an organic light emitting diode (OLED) panel, or a quantum dot (QD) panel.

The optical arrangement 20 is configured to convey light from the pixels of the display panel 18 to a viewer. The optical arrangement 20 may, for example, comprise an array of optical elements such as lenses. The array of optical elements may be arranged in columns and rows, where the rows are substantially perpendicular to the columns. The optical arrangement 20 may be fixed relative to the display panel 18.

FIG. 2 illustrates a control apparatus 8 comprising processing circuitry 12 and a memory 14. The processing circuitry 12 may comprise a single processor or multiple processors.

The processing circuitry 12 is configured to read from and write to the memory 14. The processing circuitry 12 may also comprise an output interface via which data and/or commands are output by the processing circuitry 12 and an input interface via which data and/or commands are input to the processing circuitry 12.

Although the memory 14 is illustrated as a single component it may be implemented as one or more separate components, some or all of which may be integrated/removable and/or may provide permanent/semi-permanent/dynamic/cached storage.

The illustrated memory 14 stores a computer program 13 comprising computer program instructions 11 that control the operation of the electronic apparatus 10 illustrated in FIG. 3 when loaded into the processing circuitry 12. The computer program instructions 11 provide the logic and routines that enables the electronic apparatus 10 to perform the method illustrated in FIG. 8. The processing circuitry 12, by reading the memory 14, is able to load and execute the computer program instructions 11.

The computer program 13 may arrive at the electronic apparatus 10 via any suitable delivery mechanism 24. The delivery mechanism 24 may be, for example, a tangible, non-transitory computer-readable storage medium, a computer program product, a memory device, a record medium such as a CD-ROM, DVD or Blu-Ray disc, or any article of manufacture that tangibly embodies the computer program 13. The delivery mechanism 24 may be a signal configured to reliably transfer the computer program 13.

The electronic apparatus 10 comprises the display apparatus 6 illustrated in FIG. 1 and the control apparatus 8 illustrated in FIG. 2. The processing circuitry 12 is configured to control the pixels of the display panel 18.

The electronic apparatus 10 further comprises one or more orientation detectors 15 and, optionally, one or more radio frequency transceivers 16. The orientation detector(s) 15 is/are configured to provide an input to the processing circuitry 12 and may comprise one or more accelerometer(s) and/or a gyroscope. The input from the orientation detector(s) 15 enables the processing circuitry 12 to determine the (expected) orientation of the display panel 18 relative to the (expected) position of a viewer holding the electronic apparatus 10.

In some embodiments of the invention, the electronic apparatus 10 may comprise a sliding keyboard and the orientation detector(s) 15 may comprise a switch that enables the processing circuitry 12 to determine whether the keyboard has been slid open for use. The processing circuitry 12 may determine that the electronic device 10 (and therefore the display panel 18) has a particular orientation when the keyboard has been slid open. For example, the keyboard may have a configuration (for instance, a QWERTY configuration) that means that when it has been slid open, the electronic device 10 is likely to be in a particular orientation.

The radio frequency transceiver(s) 16 is/are configured to transmit and receive radio frequency signals. The radio frequency transceiver(s) 16 may, for example, include a cellular transceiver that is compatible with one or more cellular protocols such as GSM (Global System for Mobile Communications), IS-95 (Interim Standard 95) or UMTS (Universal Mobile Telecommunications System). Alternatively or additionally, the radio frequency transceiver(s) 16 may include a short range transceiver that is compatible with one or more short range protocols, such as Bluetooth protocols or IEEE (Institute of Electrical and Electronic Engineers) protocols.

The electronic apparatus 10 may be a hand portable electronic device such as a mobile telephone, a tablet computer, a music player or a games console.

The elements 12, 14, 15, 16, 18 and 20 are operationally coupled and any number or combination of intervening elements can exist (including no intervening elements).

FIG. 4 illustrates a portion of the display panel 18. FIG. 4 also illustrates a co-ordinate system 150 to assist the reader in orientating the display panel 18 in subsequent figures. In the illustrated co-ordinate system 150, the x and y axes are parallel with the plane of the page. The z axis is perpendicular to the plane of the page and extends out of the page. The length of the display panel 18 is parallel to the illustrated y axis. The width of the display panel 18 is parallel to the illustrated x axis.

The display panel 18 comprises a plurality of pixels, arranged in columns and rows. The pixel columns are arranged vertically in FIG. 4 and are labelled PC1 to PC16. The pixel rows are arranged horizontally (substantially perpendicular to the columns) and are labelled PR1 to PR16.

The pixels of the display panel 18 can be considered to be organized in ‘pixel groups’. In the illustrated example, each pixel group comprises four pixels, arranged in a 2×2 array.

The display panel 18 illustrated in FIG. 4 includes 8 pixel group columns, labelled PGC1 to PGC8, and eight pixel group rows, labelled PGR1 to PGR8. For example, the pixel group row labelled PGR1 includes the pixel groups 19a-19h. The pixel group column labelled PGC1 includes the pixel groups 19a and 19i-19o.

The pixel group 19a in the upper left hand corner includes pixels 1-4 in a 2×2 array. Pixels 1 and 2 are in a first column PC1 and pixels 3 and 4 are in a second column PC2. Pixels 1 and 3 are in a first row PR1 and pixels 2 and 4 are in a second row PR2.

In embodiments of the invention, the optical arrangement 20 overlies the display panel 18. The optical arrangement 20 may be spaced from the display panel 18 and fixed relative to the display panel 18. There may or may not be intervening elements between the display panel 18 and the optical arrangement 20. The optical arrangement 20 includes plurality of different optical systems. There is a different optical system for each pixel group. Each optical system includes at least one optical element.

For example, the optical arrangement 20 may include an array of optical elements arranged in rows and columns, where at least one optical element overlies a pixel group.

In some embodiments of the invention, some or all of the optical elements are lenses (such as a curved convex lens or a Fresnel lens). In other embodiments of the invention, some or all of the optical elements are holographic optical elements of a holographic optical device.

Each pixel group has a centre point. The centre point is the point where a corner of each pixel meets a corner of the other three pixels in a pixel group. FIG. 4 illustrates the centre point 5 for the pixel group 19a. The optical system for the pixel group 19a has an optical axis (alternatively called a virtual centre line) that travels through the point 5 (into the page in FIG. 4).

FIG. 5 illustrates the optical axis 50 of the optical system for the pixel group 19a, along with optical axes 51-54 for the optical systems of other pixel groups across the display panel 18. The optical axes 50-54 of the pixel groups converge on a focal point 55. The focal point 55 is situated at an expected viewed position for a viewer. The focal point 55 is situated between the viewer's eyes 60, 61.

The optical systems may be configured such that the focal point 55 is positioned at a distance from the display panel 18 that corresponds with the most comfortable (or desirable) viewing position for a viewer.

A method according to embodiments of the invention will now be described in relation to FIGS. 6A, 6B, 7A, 7B and 8. At step 801 of FIG. 8, the display panel 18 is in a first orientation, which may be a portrait orientation as illustrated in FIG. 6B. The processing circuitry 12 determines that the display panel 18 is in the first orientation using one or more inputs from the orientation detector(s) 15. Following this determination, the processing circuitry 12 controls the display panel 18 to cause an auto-stereoscopic image to be conveyed to a viewer. The auto-stereoscopic image includes content that is orientated in accordance with the orientation of the display panel 18 in FIG. 6B.

The processing circuitry 12 causes an auto-stereoscopic image to be provided to he viewer by controlling first and second pixels in each pixel group to display a first image of the auto-stereoscopic image, and by controlling third and fourth pixels in each pixel group to display a second image of the auto-stereoscopic image. The first and second images are different.

The first and second pixels are the leftmost pixels from the perspective of a viewer facing the display panel 18. The third and fourth pixels are the rightmost pixels from the position of a viewer facing the display panel 18. FIG. 6A illustrates an example of a pixel group 19a from the display panel 18. The first and second pixels are denoted with the reference numerals 1 and 2 respectively and the third and fourth pixels are denoted with the reference numerals 3 and 4 respectively. The first pixel 1 is positioned above the second pixel 2 and the third pixel 3 is positioned above the fourth pixel 4.

The optical arrangement 20 is configured to use the first and second pixels 1, 2 to provide the first image of the auto-stereoscopic image to a first eye of the viewer (for example, the viewer's right eye). The optical arrangement 20 is configured to use the third and fourth pixels 3, 4 to provide the second image of the auto-stereoscopic image to a second eye of the viewer's (for example, the viewer's left eye).

In effect, alternate columns of pixels (in this example, the odd columns PC1, PC3, etc.) are used to provide the first image of the auto-stereoscopic image. The other columns of pixels (in this example, the even columns PC2, PC4, etc) are used to provide the second image of the auto-stereoscopic image.

The optical arrangement 20 is configured such that, from the viewing position illustrated in FIG. 5 the first image of the auto-stereoscopic image is viewable by the first eye of the viewer without simultaneously viewing the second image. The optical arrangement 20 is also configured such that, from the viewing position 44, the second image of the auto-stereoscopic image is viewable by the second eye of the viewer without simultaneously viewing the first image.

In this example, when displaying the first image of an auto-stereoscopic image while the display panel 18 is in the first (portrait) orientation, the first pixel 1 in each pixel group displays the same colour as the second pixel 2 in its pixel group. However, the first and second pixels 1, 2 in a pixel group need not display the same colour as the first and second pixels 1, 2 in another pixel group. For example, the first and second pixels 1, 2 in pixel group 19a display the same colour (as illustrated in FIG. 6A by hatching). The first and second pixels 1, 2 in a different pixel group (for example, pixel group 19b) both display the same colour, which may be the same or different to the first and second pixels 1, 2 in pixel group 19a.

When displaying the second image of an auto-stereoscopic image while the electronic device is in the first (portrait) orientation, the third pixel 3 in each pixel group displays the same colour as the fourth pixel 4 in its pixel group However, the third and fourth pixels 3, 4 in a pixel group need not display the same colour as the third and fourth pixels 3, 4 in another pixel group. For example, the third and fourth pixels 3, 4 in pixel group 19a display the same colour (as illustrated in FIG. 6A by hatching). The third and fourth pixels 3, 4 in a different pixel group (for example, pixel group 19b) both display the same colour, which may be the same or different to the third and fourth second pixels 3, 4 in pixel group 19a.

In block 802 of FIG. 8, the processing circuitry 12 determines, using inputs provided by the orientation detector(s) 15, that the viewer has changed the orientation of the display panel 18 to a second orientation. In this example, the viewer has rotated the electronic device 10 by approximately 90 degrees in an anti-clockwise direction, to place the display panel 18 in a landscape orientation as illustrated in FIG. 7B.

After determining that the display panel 18 is in the landscape orientation, the processing circuitry 12 controls the display panel 18 to cause a further auto-stereoscopic image to be conveyed to a viewer. The further auto-stereoscopic image may include some or all of content of the auto-stereoscopic image displayed when the device was in the first orientation (as illustrated in FIG. 6B), but the content is now orientated in accordance with the orientation of the display panel 18 in FIG. 7B.

The processing circuitry 12 may automatically change from i) controlling the display panel 18 to display the auto-stereoscopic image, to ii) controlling the display panel 18 to display the further auto-stereoscopic image, in response to a change in the orientation of the display panel 18 from the first (portrait) orientation to the second (landscape) orientation.

When the display panel 18 is in the second (landscape) orientation, the processing circuitry 12 controls the first and third pixels 1, 3 in each pixel group to display a first image of the further auto-stereoscopic image and second and fourth pixels 2, 4 in each pixel group to display a second image of the further auto-stereoscopic image. The first and second images are different.

The first and third pixels 1, 3 are the leftmost pixels from the position of a viewer facing the display panel 18. The second and fourth pixels 2, 4 are the rightmost pixels from the position of a viewer facing the display panel 18. FIG. 7A illustrates a pixel group 19a from the display panel 18. In the illustrated example, the third pixel 3 is positioned above the first pixel 1 and the fourth pixel 4 is positioned above the second pixel 2.

The optical arrangement 20 is configured to use the first and third pixels 1, 3 to provide the first image of the further auto-stereoscopic image to a first eye of the viewer (for example, the viewer's right eye). The optical arrangement 20 is configured to use the second and fourth pixels 2, 4 to provide the second image of the further auto-stereoscopic image to a second eye of the viewer's (for example, the viewer's left eye).

In effect, alternate rows of pixels (in this example, the odd rows PR1, PR3, etc.) are used to provide the first image of the further auto-stereoscopic image. The other rows of pixels (in this example, the even columns PR2, PR4, etc) are used to provide the second image of the further auto-stereoscopic image.

The optical arrangement 20 is configured such that the first image of the further auto-stereoscopic image is viewable by the first eye of the viewer without simultaneously viewing the second image. The optical arrangement 20 is also configured such that the second image of the further auto-stereoscopic image is viewable by the second eye of the viewer without simultaneously viewing the first image.

In this example, when displaying the first image of a further auto-stereoscopic image while the display panel 18 is in the second (landscape) orientation, the first pixel 1 in each pixel group displays the same colour as the third pixel 3 in its pixel group. However, the first and third pixels 1, 3 in a pixel group need not display the same colour as the first and third pixels 1, 3 in another pixel group. For example, the first and third pixels 1, 3 in pixel group 19a display the same colour (as illustrated in FIG. 7A by hatching). The first and third pixels in a different pixel group (for example, pixel group 19b) both display the same colour, which may be the same or different to the first and third pixels 1, 3 in pixel group 19a.

The second pixel 2 in each pixel group displays the same colour as the fourth pixel 4 in its pixel group when displaying the second image of a further auto-stereoscopic image when the display panel 18 is in the second (landscape) orientation. However, the second and fourth pixels in a pixel group 2, 4 need not display the same colour as the second and fourth pixels in another pixel group. For example, the second and fourth pixels 2, 4 in pixel group 19a display the same colour (as illustrated in FIG. 7A by hatching). The second and fourth pixels in a different pixel group (for example, pixel group 19b) both display the same colour, which may be the same or different to the second and fourth second pixels 2, 4 in pixel group 19a.

In the embodiments of the invention described above, the resolution of the auto-stereoscopic image and the further auto-stereoscopic image is a quarter of the resolution of the display panel 18, because each pixel group is used to provide one viewable pixel.

The processing circuitry 12 may be configured to control the display panel to display a two dimensional (non-stereoscopic) image. In this situation, the full resolution of the display panel 18 might be used, or the two dimensional image may have a quarter of the (total possible) resolution of the display panel 18. In the former case, every pixel of the display panel may be used to display a different colour. In the latter case, each of the pixels in a pixel group display the same colour as one another. Different pixel groups may, however, display different colours.

Three different embodiments of the optical arrangement 20 will now be described. Any of these embodiments may be used to provide the optical effects described above in relation to FIGS. 6A to 8 above.

The first embodiment of the optical arrangement 20a is described below in relation to FIGS. 9 to 12. In the first embodiment, the optical system for each pixel group consists of a single optical element per pixel group.

The second embodiment of the optical arrangement 20b is described below in relation to FIGS. 13A to 15. In the second embodiment, the optical system for each pixel group consists of a single optical element per pixel.

The third embodiment is of the optical arrangement 20c is described below in relation to FIGS. 16 to 19. In the third embodiment, the optical system for each pixel group consists of a single optical element per sub-pixel of a pixel.

In each of the first, second and third embodiments of the optical arrangement 20a, 20b, 20c, the optical arrangement 20a, 20b, 20c comprises a plurality of optical elements arranged in columns and rows, where the rows are orthogonal to the columns. The optical arrangement 20a overlies the display panel 18. The optical arrangement 20a is spaced from the display panel 18, and is fixed in relation to the display panel 18.

### The First Embodiment of the Optical Arrangement

In the first embodiment of the optical arrangement 20a, each of the optical elements of the optical arrangement 20a overlies a single pixel group. A portion of the optical arrangement 20a is illustrated in FIG. 9. Four optical elements 21a to 21d of the optical arrangement 20a are illustrated. A single optical element 21a to 21d overlies a single pixel group 19a to 19d.

FIG. 10A relates to a situation where the display panel 18 is in the first (portrait) orientation. It is a plan view ray diagram illustrating how first and second images of an auto-stereoscopic image are conveyed to a viewer by the first embodiment of the optical arrangement 20a.

The optical element 21a overlies the pixel group 19a of the display panel 18. The optical axis 50 extends through the centre of the optical element 21a. In this example the optical element 19a is a curved convex lens, but in other examples it may be a Fresnel lens or a holographic optical element.

As explained above in relation to FIGS. 6A and 6B, when the display panel 18 is in the first (portrait) orientation, the first and second pixels 1, 2 in each pixel group are used to provide a first image of an auto-stereoscopic image to the right eye of a viewer. The third and fourth pixels 3, 4 in each pixel group are used to provide a second image of the auto-stereoscopic image to the left eye of the viewer.

Rays 71-74 represent light emanating from the first pixel 1 of the pixel group 19a. The optical element 21a directs the light emanating from the first pixel 1 towards the right eye 60 of the viewer. The rays 71 and 74 represent the periphery of the field of vision of the right eye 60.

Rays 75-78 represent light emanating from the third pixel 3 of the pixel group 19a. The optical element 21a directs the light emanating from the third pixel 3 towards the left eye 61 of the viewer. The rays 75 and 78 represent the periphery of the field of vision of the left eye 61.

The zones 82a and 82b collectively represent the “zone of visibility for both eyes 60, 61”. In the FIG. 10A illustration, the zone 82a is positioned between the display panel 18 and the optical element 21a and is bounded by the rays 71 and 78. The zone 82b is positioned behind the display panel 18 and is bounded by the rays 74 and 75. If a portion of the surface of the display panel 18 were positioned in either of the zones 82a or 82b, that portion would be seen by both of the viewer's eyes 60, 61.

The zones 80a and 80b collectively represent the “zone of visibility for the left eye 61”. In the FIG. 10A illustration, the zone 80a is positioned between the display panel 18 and the optical arrangement 21a and is bounded by the rays 71, 75 and 78. The zone 80b is positioned behind the illustrated display panel 18 and is bounded by the rays 74, 75 and 78. If a portion of the surface of the display panel 18 were positioned in either of the zones 80a or 80b, that portion would be seen by the viewer's left eye 61 but not his right eye 60.

The zones 81a and 81b collectively represent the “zone of visibility for the right eye 60”. If a portion of the display panel 18 were positioned in either of the zones 81a or 81b, that portion would be seen by the viewer's right eye 60 but not his left eye 61.

In this embodiment of the invention, the display panel 18 can be positioned anywhere between the dotted lines 83 and 84. If this is the case, the first pixel 1 is visible to the right eye 60 but not the left eye 61, and the third pixel 3 is visible to the left eye 61 but not the right eye 60. This enables an auto-stereoscopic image to be conveyed to the viewer.

A plan view light ray diagram for the second and fourth pixels 2, 4 could be drawn in which the ray arrangement would reflect that of FIG. 10A. Such a diagram would illustrate light emanating from the second pixel 2 being directed towards the right eye 60 by the optical element 21a, and light emanating from the fourth pixel 4 being directed towards the left eye 61 by the optical element 21a. However, this diagram is omitted here for conciseness.

FIG. 10B illustrates the pixel group 19a from the side, when the display panel 18 is in the first (portrait) orientation. The ray 85 represents light emanating from the first pixel 1. The optical element 21a directs light emanating from the first pixel 1 downwardly towards the right eye 60 of the viewer. The ray 86 represents light emanating from the second pixel 2. The optical element 21a directs light emanating from the second pixel 2 to upwardly to the right eye 60 of the viewer.

It can be seen from FIG. 10B that the viewer's right eye 60 sees a portion of the first pixel 1 and a portion of the second pixel 2. The zones 87a and 87b are bounded by the rays 85 and 86 and represent the “zone of visibility for the right eye 60” in FIG. 10B. If a portion of the surface of the display panel 18 is positioned in either of these zones 87a, 87b, that portion is seen by viewer's right eye 60.

A side view light ray diagram for the third and fourth pixels 3, 4 could be drawn in which the ray arrangement would reflect that of FIG. 10B. Such a diagram would illustrate light emanating from the third pixel 3 being directed downwardly by the optical element 21a towards the left eye 61 of the viewer, and light emanating from the fourth pixel 4 being directed upwardly by the optical element 21a towards the left eye 61 of the viewer. However, this diagram is omitted here for conciseness.

FIG. 10C illustrates the areas 88, 89 of the pixel group 19a that are visible to the viewer. As mentioned above, when the display panel 18a is in the first (portrait) orientation, the first and second pixels 1, 2 in a pixel group 19a are the same colour and the third and fourth pixels 3, 4 are the same colour. The area 88 encompassing part of the first pixel 1 and part of the second pixel 2 is seen by the viewer's right eye 60. This causes the viewer's right eye 60 to perceive the optical element 21a to be coloured with the same colour as the first and second pixels 1, 2. Each optical element 21a effectively represents a single viewable pixel (having the same colour of the first and second pixels 1, 2) with respect to the image seen by the viewer's right eye 61.

The area 89 encompassing part of the third pixel 1 and part of the fourth pixel 4 is seen by the viewer's left eye 61. This causes the viewer's left eye 61 to perceive the optical element 21a to be coloured with the same colour as the third and fourth pixels 3, 4. Each optical element 21a effectively represents a single viewable pixel (having the same colour of the third and fourth pixels 3, 4) with respect to the image seen by the viewer's left eye 61.

FIG. 11A relates to a situation where the display panel 18 is in the second (landscape) orientation. It is a plan view ray diagram illustrating how first and second images of an auto-stereoscopic image are conveyed to a viewer by the optical arrangement 20a.

As explained above in relation to FIGS. 7A and 7B, when the display panel 18 is in the second (landscape) orientation, the first and third pixels 1, 3 in each pixel group are used to provide a first image of an auto-stereoscopic image to the right eye of a viewer. The second and fourth pixels 2, 4 in each pixel group are used to provide a second image of the auto-stereoscopic image to the left eye of the viewer.

Rays 171-174 represent light emanating from the third pixel 3 of the pixel group 19a. The optical element 21a directs the light emanating from the third pixel 3 towards the right eye 60 of the viewer. The rays 171 and 174 represent the periphery of the field of vision of the right eye 60.

Rays 175-178 represent light emanating from the fourth pixel 4 of the pixel group 19a. The optical element 21a directs the light emanating from the fourth pixel 4 towards the left eye 61 of the viewer. The rays 175 and 178 represent the periphery of the field of vision of the left eye 61.

The zones 182a and 182b collectively represent the “zone of visibility for both eyes 60, 61”. In the FIG. 11A illustration, the zone 182a is positioned between the display panel 18 and the optical element 21a and is bounded by the rays 171 and 178. The zone 182b is positioned behind the display panel 18 and is bounded by the rays 174 and 175. If a portion of the surface of the display panel 18 were positioned in either of the zones 182a or 182b, that portion would be seen by both of the viewer's eyes 60, 61.

The zones 180a and 180b collectively represent the “zone of visibility for the left eye 61”. In the FIG. 11A illustration, the zone 180a is positioned between the display panel 18 and the optical arrangement 21a and is bounded by the rays 171, 175 and 178. The zone 180b is positioned behind the illustrated display panel 18 and is bounded by the rays 174, 175 and 178. If a portion of the surface of the display panel 18 were positioned in either of the zones 180a or 180b, that portion would be seen by the viewer's left eye 61 but not his right eye 60.

The zones 181a and 181b collectively represent the “zone of visibility for the right eye 60”. If a portion of the display panel 18 were positioned in either of the zones 181a or 181b, that portion would be seen by the viewer's right eye 60 but not his left eye 61.

In this embodiment of the invention, the display panel 18 can be positioned anywhere between the dotted lines 183 and 184. If this is the case, the third pixel 3 is visible to the right eye 60 but not the left eye 61, and the fourth pixel 4 is visible to the left eye 61 but not the right eye 60. This enables an auto-stereoscopic image to be conveyed to the viewer.

A plan view light ray diagram for the first and second pixels 1, 2 could be drawn in which the ray arrangement would reflect that of FIG. 11A. Such a diagram would illustrate light emanating from the first pixel 1 being directed towards the right eye 60 by the optical element 21a, and light emanating from the second pixel 2 being directed towards the left eye 61 by the optical element 21a. However, this diagram is omitted here for conciseness.

FIG. 11B illustrates the pixel group 19a from the side, when the display panel 18 is in the second (landscape) orientation. The ray 185 represents light emanating from the third pixel 3. The optical element 21a directs light emanating from the third pixel 3 downwardly towards the right eye 60 of the viewer. The ray 186 represents light emanating from the first pixel 1. The optical element 21a directs light emanating from the first pixel 1 to upwardly to the right eye 60 of the viewer.

It can be seen from FIG. 11B that the viewer's right eye 60 sees a portion of the third pixel 3 and a portion of the first pixel 1. The zones 187a and 187b are bounded by the rays 185 and 186 and represent the “zone of visibility for the right eye 60” in FIG. 11B. If a portion of the surface of the display panel 18 is positioned in either of these zones 187a, 187b, that portion is seen by viewer's right eye 60.

A side view light ray diagram for the second and fourth pixels 2, 4 could be drawn in which the ray arrangement would reflect that of FIG. 11B. Such a diagram would illustrate light emanating from the fourth pixel 4 being directed downwardly by the optical element 21a towards the right eye 60 of the viewer, and light emanating from the second pixel 2 being directed upwardly by the optical element 21a towards the right eye 60 of the viewer. However, this diagram is omitted here for conciseness.

FIG. 11C illustrates the areas 188, 189 of the pixel group 19a that are visible to the viewer. As mentioned above, when the display panel 18a is in the second (landscape) orientation, the first and third pixels 1, 3 in a pixel group 19a are the same colour and the second and fourth pixels 2, 4 are the same colour. The area 188 encompassing part of the first pixel 1 and part of the third pixel 3 is seen by the viewer's right eye 60. This causes the viewer's right eye 60 to perceive the optical element 21a to be coloured with the same colour as the first and third pixels 1, 3. Each optical element 21a effectively represents a single viewable pixel (having the same colour of the first and third pixels 1, 3) with respect to the image seen by the viewer's right eye 60.

The area 189 encompassing part of the second pixel 2 and part of the fourth pixel 4 is seen by the viewer's left eye 61. This causes the viewer's left eye 61 to perceive the optical element 21a to be coloured with the same colour as the second and fourth pixels 2, 4. Each optical element 21a effectively represents a single viewable pixel (having the same colour of the second and fourth pixels 2, 4) with respect to the image seen by the viewer's left eye 61.

FIG. 12 illustrates a suitable Fresnel lens for use as an optical element in the first embodiment of the optical arrangement 20. A plan view 90 and a cross-sectional view 91 of the Fresnel lens are illustrated.

### The Second Embodiment of the Optical Arrangement

In the second embodiment of the optical arrangement 20b, the optical arrangement 20b comprises at least one holographic optical device and the optical elements are holographic optical elements. Each of the holographic optical elements of the optical arrangement 20b overlies a single pixel of the display panel 18.

Each of the optical elements in an optical system for a pixel group is configured to direct light in a different direction to the other optical elements to enable auto-stereoscopic images to be viewed when the display panel 18 is a first (portrait) orientation and a second (landscape) orientation. This is explained in more detail below.

FIG. 13A relates to a situation where the display panel 18 is in the first (portrait) orientation. It is a plan view ray diagram illustrating how first and second images of an auto-stereoscopic image are conveyed to a viewer by the second embodiment of the optical arrangement 20b.

As explained above in relation to FIGS. 6A and 6B, when the display panel 18 is in the first (portrait) orientation, the first and second pixels 1, 2 in each pixel group are used to provide a first image of an auto-stereoscopic image to the right eye of a viewer. The third and fourth pixels 3, 4 in each pixel group are used to provide a second image of the auto-stereoscopic image to the left eye of the viewer.

The optical element 21e overlies the third pixel 3 in a pixel group 19a of the display panel 18. The optical element 21f overlies the first pixel 1 in the pixel group 19a. Optical elements also overlie the second and fourth pixels 1, 4 in the pixel group 19a.

The optical axis/virtual centre line 50 of the optical system for the pixel group 19a extends through the centre point 5 of the pixel group 19a.

The optical element 21f overlying the first pixel 1 is configured to direct light from the first pixel 1 rightwards and downwards, from the perspective of a viewer viewing the display panel 18 by looking in the −z direction in FIG. 13A. The area 228 defined by the dotted line 220 illustrates the direction in which the optical element 21f directs light from the green sub-pixel 1b in the x-y plane.

The rays 222 and 223 illustrate light being directed by the optical element 21f from the green-sub pixel 1b to the right eye 60 of the viewer.

The optical element 21e overlying the third pixel 3 is configured to direct light from the third pixel 3 leftwards and downwards, from the perspective of a viewer viewing the display panel 18 by looking in the −z direction in FIG. 13A. The area 229 defined by the dotted line 221 illustrates the direction in which the optical element 21e directs light from the green sub-pixel 3b in the x-y plane.

The rays 226 and 227 illustrate light being directed by the optical element 21e from the green sub-pixel 3b to the left eye 61 of the viewer.

In the example illustrated in FIG. 13A, the viewing position of the viewer, relative to the direction in which light is being directed by the optical elements 21e, 21f, means that the third pixel 3 is not visible to the right eye 60 of the viewer and the first pixel 1 is not visible to the left eye 61 of the viewer. The optical element 21e appears to be dark to the right eye 60 and the optical element 21f appears to be dark to the left eye 61.

FIG. 13A illustrates light from the green-sub-pixels 1b, 3b being directed by the optical elements 21e, 21f for illustrative purposes. The optical element 21e is also configured to direct light from the other sub-pixels 3a, 3c of the third pixel 3 in substantially the same direction as the light from the green sub-pixel 3b.

Due to the difference in positioning of each of the sub-pixels 3a, 3b, 3c relative to the optical element 21e, the extent to which the optical element 21e “bends” light may depend upon the colour of the light incident upon the optical element 21e. This enables a single colour hue to be provided to the left eye 61 from the third pixel 3, rather than spatially separated red, green and blue colours.

Similarly, the optical element 21f is also configured to direct light from the other sub-pixels 1a, 1c of the first pixel 1 in substantially the same direction as the light from the green sub-pixel 1b. Due to the difference in positioning of each of the sub-pixels 1a, 1b, 1c relative to the optical element 21f, the extent to which the optical element 21f “bends” light may depend upon the colour of the light incident upon the optical element 21d. This enables a single colour hue to be provided to the right eye 60 from the first pixel 1, rather than spatially separated red, green and blue colours. The other optical elements of the optical arrangement 20b are configured in a similar manner. The second and fourth pixels 2, 4 and their associated optical elements are not shown in FIG. 13A. In the context of the FIG. 13A example, the optical element associated with the second pixel 2 is configured to direct light rightwards and upwards, from the perspective of a viewer viewing the display panel 18 by looking in the −z direction. The optical element associated with the fourth pixel 4 is configured to direct light leftwards and upwards from the perspective of the same viewer.

FIG. 13B illustrates the pixel group 19a from the side, when the display panel 18 is in the first (portrait) orientation. The area 235 defined by the dotted line 231 illustrates the direction in which the optical element 21e directs the light from the green sub-pixel 3b in the y-z plane. Rays 232 and 238 illustrate light being directed from the green sub-pixel 3b to the left eye 61 of the viewer by the optical element 21e.

The area 234 defined by the dotted line 230 illustrates the direction in which the optical element 21f directs the light from the green sub-pixel 4b in the y-z plane. Rays 233 and 239 illustrate light being directed from the green sub-pixel 4b to the left eye 61 of the viewer.

It can be seen from FIG. 13B that a portion of the green sub-pixel 3b of the third pixel 3 and a portion of the green sub-pixel 4b of the fourth pixel 4 is visible to the left eye 61 of the viewer.

A similar diagram to FIG. 13B could be produced for the other sub-pixels 3a, 3c, 4a, 4c of the third and fourth pixels 3, 4. A similar diagram to FIG. 13B could also be produced for the sub-pixels of the first and second pixels 1, 2. Such a diagram would show that a portion of both the first and second pixels 1, 2 is visible to the right eye 60 of the viewer. However, these diagrams are omitted here for conciseness.

FIG. 13C illustrates the areas 236a-236f, 237a-237f of the pixel group 19a that are visible to the viewer, when the display panel 18 is in the first (portrait) orientation. The areas 236a-236c indicate the areas of the blue 1a, green 1b and red 1c sub-pixels that are visible to the right eye 60 of the viewer. The areas 236d-236f indicate the areas of the blue 2a, green 2b and red 2c sub-pixels that are visible to the right eye 60 of the viewer. The areas 237a-237c indicate the areas of the blue 3a, green 3b and red 3c sub-pixels that are visible to the left eye 61 of the viewer. The areas 237d-237f indicate the areas of the blue 4a, green 4b and red 4c sub-pixels that are visible to the left eye 61 of the viewer.

FIG. 14A relates to a situation where the display panel 18 is in the second (landscape) orientation. It is a plan view ray diagram illustrating how first and second images of an auto-stereoscopic image are conveyed to a viewer by the second embodiment of the optical arrangement 20b.

As explained above in relation to FIGS. 7A and 7B, when the display panel 18 is in the second (landscape) orientation, the first and third pixels 1, 3 in each pixel group are used to provide a first image of an auto-stereoscopic image to the right eye of a viewer. The second and fourth pixels 2, 4 in each pixel group are used to provide a second image of the auto-stereoscopic image to the left eye of the viewer.

As mentioned above, the optical element 21e overlies the third pixel 3 in a pixel group 19a of the display panel 18. The optical element 21g overlies the fourth pixel 4 in the pixel group 19a.

The optical element 21e overlying the third pixel 3 is configured to direct light from the third pixel 3 rightwards and downwards, from the perspective of a viewer viewing the display panel 18 by looking in the −z direction in FIG. 14A. The area 242 defined by the dotted line 240 illustrates the direction in which the optical element 21e directs light from the green sub-pixel 3b in the y-z plane.

The rays 244 and 245 illustrate light being directed by the optical element 21e from the green-sub pixel 3b to the right eye 60 of the viewer.

The optical element 21g overlying the fourth pixel 4 is configured to direct light from the fourth pixel 4 leftwards and downwards, from the perspective of a viewer viewing the display panel 18 by looking in the −z direction in FIG. 14A. The area 243 defined by the dotted line 241 illustrates the direction in which the optical element 21g directs light from the green sub-pixel 4b in the y-z plane.

The rays 246 and 247 illustrate light being directed by the optical element 21g from the green sub-pixel 4b to the left eye 61 of the viewer.

In the example illustrated in FIG. 14A, the viewing position of the viewer, relative to the direction in which light is being directed by the optical elements 21e, 21g, means that the fourth pixel 4 is not visible to the right eye 60 of the viewer and the third pixel 3 is not visible to the left eye 61 of the viewer. The optical element 21g appears to be dark to the right eye 60 and the optical element 21e appears to be dark to the left eye 61.

FIG. 14A illustrates light from the green-sub-pixels 3b, 4b being directed by the optical elements 21e, 21g for illustrative purposes. The optical element 21g is also configured to direct light from the other sub-pixels 4a, 4c of the fourth pixel 4 in substantially the same direction as the light from the green sub-pixel 4b.

The first and second pixels 1, 2 and their associated optical elements are not shown in FIG. 14A. In the context of the FIG. 14A example, the optical element associated with the first pixel 1 is configured to direct light rightwards and upwards, from the perspective of a viewer viewing the display panel by looking in the −z direction. The optical element associated with the second pixel 2 is configured to direct light leftwards and upwards from the perspective of the same viewer.

FIG. 14B illustrates the pixel group 19a from the side, when the display panel 18 is in the second (landscape) orientation. The area 252 defined by the dotted line 250 illustrates the direction in which the optical element 21f directs the light from the green sub-pixel 1b in the x-z plane. Rays 257 and 258 illustrate light being directed from the green sub-pixel 1b to the left eye 61 of the viewer by the optical element 21f.

The area 253 defined by the dotted line 251 illustrates the direction in which the optical element 21e directs the light from the green sub-pixel 3b in the x-z plane. Rays 255 and 256 illustrate light being directed from the green sub-pixel 3b to the left eye 61 of the viewer.

It can be seen from FIG. 14B that a portion of the green sub-pixel 1b of the first pixel 1 and a portion of the green sub-pixel 3b of the third pixel 3 is visible to the left eye 61 of the viewer.

A similar diagram to FIG. 14B could be produced for the other sub-pixels 1a, 1c, 3a, 3c of the first and third pixels 1, 3. A similar diagram to FIG. 14B could also be produced for the sub-pixels of the second and fourth pixels 2, 4. Such a diagram would show that a portion of both the second and fourth pixels 2, 4 is visible to the right eye 60 of the viewer. However, these diagrams are omitted here for conciseness.

FIG. 14C illustrates the areas 260a-260f, 261a-261f of the pixel group 19a that are visible to the viewer, when the display panel 18 is in the second (landscape) orientation. The areas 260a-260c indicate the areas of the blue 3a, green 3b and red 3c sub-pixels that are visible to the right eye 60 of the viewer. The areas 260d-260f indicate the areas of the blue 1a, green 1b and red 1c sub-pixels that are visible to the right eye 60 of the viewer. The areas 261a-261c indicate the areas of the blue 4a, green 4b and red 4c sub-pixels that are visible to the left eye 61 of the viewer. The areas 261d-261f indicate the areas of the blue 2a, green 2b and red 2c sub-pixels that are visible to the left eye 61 of the viewer.

FIG. 15 illustrates a switchable embodiment of the display apparatus 6 illustrated in FIG. 1 comprising the second embodiment of the optical apparatus 20b.

The reference numeral 272 denotes a magnified version of the display apparatus 6 in FIG. 15. The illustrated display apparatus 6 comprises the display panel 18, a polarizing layer 271, a liquid crystal layer 270 and the optical arrangement 20b. The polarizing layer 271 is situated between the display panel 18 and the liquid crystal layer 270. The liquid crystal layer 270 is situated between the optical arrangement 20b and the polarizing layer 271.

In the FIG. 15 embodiment, the optical arrangement 20b is configured to direct light, having a first polarization, from the display panel 18 to provide a viewable auto-stereoscopic image. However, if the light emanating from the display panel 18 does not have the first polarization, the optical arrangement 20b does not direct the light in the same manner.

The liquid crystal element 270 is controlled by the processing circuitry 12. The processing circuitry 12 has an auto-stereoscopic mode and a non-stereoscopic mode. When the processing circuitry 12 switches from being in the non-stereoscopic mode to being in the auto-stereoscopic mode, it controls the liquid crystal layer 270 to polarize the light emanating from the display panel 18 such that it has the first polarization, causing the optical arrangement 20b to provide an auto-stereoscopic image.

When the processing circuitry 12 switches from being in the auto-stereoscopic mode to being in the non-stereoscopic mode, it controls the liquid crystal layer 270 cease polarizing the light emanating from the display panel 18, such that a non-stereoscopic image is viewed by the viewer.

As explained above, when the processing circuitry 12 is in the non-stereoscopic mode, it may potentially control the each individual pixel of the display panel 18 to display a different colour, such that the resolution of a displayed non-stereoscopic image is four times that of a displayed auto-stereoscopic image. Alternatively, each pixel in a pixel group may display the same colour, such that the resolution of a displayed non-stereoscopic image is the same as a displayed auto-stereoscopic image.

### The Third Embodiment of the Optical Arrangement

In the third embodiment, each of the optical elements of the optical arrangement 20c overlies (only) a single sub-pixel of a pixel. A portion of the optical arrangement 20c is illustrated in FIG. 16.

The third embodiment of the optical arrangement 20c includes a plurality of opaque optical barriers that extend from the optical elements to the display panel 18. The optical barriers divide each of the pixels in a pixel group from one another, and they divide the sub-pixels in a particular pixel from one another. The optical barriers may abut the surface of the display panel 18, or extend into the display panel 18.

FIG. 17A relates to a situation where the display panel 18 is in the first (portrait) orientation. It is a plan view ray diagram illustrating how first and second images of an auto-stereoscopic image are conveyed to a viewer by the optical arrangement 20c.

In this illustrated implementation, each of the optical elements is a portion of a curved convex lens. In other implementations, some or all of the optical elements may be Fresnel lenses or holographic optical elements.

As explained above in relation to FIGS. 6A and 6B, when the display panel 18 is in the first (portrait) orientation, the first and second pixels 1, 2 in each pixel group are used to provide a first image of an auto-stereoscopic image to the right eye of a viewer. The third and fourth pixels 3, 4 in each pixel group are used to provide a second image of the auto-stereoscopic image to the left eye of the viewer.

FIG. 17A illustrates the first and third pixels 1, 3 of a pixel group 19a. In the illustrated example, the optical elements 21p to 21r overlie the blue, green and red sub-pixels 3a, 3b and 3c of the third pixel 3 of the pixel group 19a. The optical elements 21s to 21 u overlie the blue, green and red sub-pixels 1a, 1b 1c of the first pixel 1 of the pixel group 19a. Further optical elements (not shown in FIG. 17A) overlie the sub-pixels 2a, 2b, 2c of the second pixel 2 and the sub-pixels 4a, 4b, 4c of the fourth pixel 4.

A first optical barrier 103a extends from a position between the optical elements 21p and 21q and optically divides the blue sub-pixel 3a from the green sub-pixel 3b. A second optical barrier 103b extends from a position between the optical elements 21q and 21r and optically divides the green sub-pixel 3b from the red sub-pixel 3c.

A third optical barrier 103c extends from a position between the optical elements 21r and 21s and optically divides the third pixel 3 from the first pixel 1. A fourth optical barrier 103d extends from a position between the optical elements 21s and 21t and optically divides the blue sub-pixel 1a from the green sub-pixel 1b. A fifth optical barrier 103e extends from a position between the optical elements 21t and 21u and optically divides the green sub-pixel 1b from the red sub-pixel 1c.

The optical elements 21p to 21u and the optical barriers 103a to 103e provide part of the optical system for the pixel group 19a. The optical system has an optical axis 50 that extends through the centre point of the illustrated pixel group 19a.

FIG. 17B illustrates a magnified portion of FIG. 17A. The light rays in FIG. 17A and FIG. 17B indicate how the right eye 60 views the first pixel 1 and the left eye 61 views the third pixel 3 when the display panel 18 is in the first (portrait) orientation.

In FIG. 17A a first plurality of bundles of rays 110-116 is illustrated. Each bundle 110-116 has been extrapolated from the right eye 60. The bundle of rays labelled with the reference numerals 110 and 116 represent the periphery of the field of view of the right eye 60. It can be seen in FIG. 17A that optical barriers 103a-103e are positioned such that they prevent the right eye 60 from seeing third pixel 3, but do not prevent the right eye 60 from seeing the first pixel 1.

This is illustrated in more detail in FIG. 17B. In FIG. 17B it can be seen clearly that the bundles of rays labelled with the reference numerals 111, 112, 114 and 115 each comprise two separate rays. FIG. 17B illustrates the rays 110, 111a, 111b, 112a, 112b meeting the optical barriers 103a, 103b and 103c prior to reaching the third pixel 3. This means that the third pixel 3 is not seen by the viewer's right eye 60.

However, the rays 114a, 114b, 115a, 115b and 116b are illustrated meeting each of the sub-pixels 1a, 1b, 1c of the first pixel 1, indicating that the right eye 60 can see the first pixel 1.

A second plurality of bundles of rays 117-122 is also illustrated in FIG. 17A. Each bundle 117-122 has been extrapolated from the left eye 61. The bundle of rays labelled with the reference numerals 117 and 122 represent the periphery of the field of view of the left eye 61. It can be seen in FIG. 17A that optical barriers 103a-103e are positioned such that they prevent the left eye 61 from seeing first pixel 1, but do not prevent the left eye 61 from seeing the third pixel 3.

This is illustrated in more detail in FIG. 17B. In FIG. 17B it can be seen clearly that the bundles of rays labelled with the reference numerals 118, 119, 121 and 122 each comprise two separate rays. FIG. 17B illustrates the rays 121a, 121b, 122a, 122b and 123 meeting the optical barriers 103c, 103d and 103e prior to reaching the first pixel 1. This means that the first pixel 1 is not seen by the viewer's left eye 61.

However, the rays 118a, 118b, 119a, 119b and 120 are illustrated meeting each of the sub-pixels 3a, 3b, 3c of the third pixel 3, indicating that the left eye 61 can see the third pixel 3.

A plan view light ray diagram for the second and fourth pixels 2, 4 could be drawn in which the optical system would reflect that of FIG. 17A. Such a diagram would illustrate:

(i) optical barriers positioned to prevent the right eye 60 from seeing the fourth pixel 4, but which enable the right eye 60 to see the second pixel 2; and
(ii) optical barriers positioned to prevent the left eye 61 from seeing the second pixel 32 but which enable the left eye 61 to see the fourth pixel 4.

However, such a diagram is omitted here for conciseness.

FIG. 17C illustrates a side view of the pixel group 19a and the optical arrangement 20c when the display panel 18 is in the first (portrait) orientation. FIG. 17C shows the viewer's left eye 61 viewing the green sub-pixels 3b, 4b of the third and fourth pixels 3, 4. The optical element 21q overlies the green sub-pixel 3b of the third pixel 3, and the optical element 21v overlies the green sub-pixel 4b of the fourth pixel 4. An optical barrier 104 extends from between the optical elements 21q and 21v to a position between the third and fourth pixels 3, 4. The optical barrier 104 divides the green sub-pixel 3b of the third pixel 3 from the green sub-pixel 4b of the fourth pixel 4.

The optical elements 21q and 21v direct light from the green sub-pixels 3b, 4b to enable them to be viewed by the viewer's left eye 61.

The rays 123 and 124 indicate the periphery of the field of vision of the left eye 61 in the y-z plane. The zones indicated by the reference numerals 125a, 125b, 126a and 126b collectively provide the “zone of visibility for the left eye 61” in the y-z plane. If a portion of the surface of the display panel 18 is positioned in this zone 125a, 125b, 126a, 126b (as shown in FIG. 17C), that portion is seen by viewer's left eye 61.

Similar diagrams to FIG. 17C could be drawn in illustrating the viewer's left eye 61 viewing the blue and red sub-pixels 3a, 3c, 4a, 4c of the third and fourth pixels 3, 4. Similar diagrams to FIG. 17C could also be drawn illustrating the viewer's right eye 60 viewing the blue, green or red sub-pixels 1a to 1c, 2a to 2c of the first and second pixels 1, 2. However, these diagrams are omitted here for conciseness.

FIG. 17D illustrates the areas 129a-129f, 130a-130f of the pixel group 19a that are visible to the viewer, when the display panel 18 is in the first (portrait) orientation. The areas 129a-129c indicate the areas of the blue 1a, green 1b and red 1c sub-pixels that are visible to the right eye 60 of the viewer. The areas 129d-129f indicate the areas of the blue 2a, green 2b and red 2c sub-pixels that are visible to the right eye 60 of the viewer. The areas 130a-130c indicate the areas of the blue 3a, green 3b and red 3c sub-pixels that are visible to the left eye 61 of the viewer. The areas 130d-130f indicate the areas of the blue 4a, green 4b and red 4c sub-pixels that are visible to the left eye 61 of the viewer.

As mentioned above, when the display panel 18 is in the first (portrait) orientation, the first and second pixels 1, 2 in a pixel group 19a are the same colour and the third and fourth pixels 3, 4 are the same colour. The proximity of the sub-pixels in each pixel means that the viewer sees an overall colour of single pixel, rather than the individual colour of the individual sub-pixels.

The colour provided by the visible areas 129a to 129f causes the viewer's right eye 60 to perceive the optical elements overlying the first and second pixels 1, 2 to be coloured with the same colour as the overall colour provided by those areas 129a-129f. The optical elements overlying the first and second pixels 1, 2 effectively represents a single viewable pixel (having the same colour of the first and second pixels 1, 2) with respect to the image seen by the viewer's right eye 60.

The colour provided by the visible areas 130a to 130f causes the viewer's left eye 61 to perceive the optical elements overlying the third and fourth pixels 3, 4 to be coloured with the same colour as the overall colour provided by those areas 130a-130f. The optical elements overlying the third and fourth pixels 3, 4 effectively represents a single viewable pixel (having the same colour of the third and fourth pixels 3, 4) with respect to the image seen by the viewer's left eye 61.

FIG. 18A relates to a situation where the display panel 18 is in the second (landscape) orientation. It is a plan view ray diagram illustrating how first and second images of an auto-stereoscopic image are conveyed to a viewer by the optical arrangement 20c.

As explained above in relation to FIGS. 7A and 7B, when the display panel 18 is in the second (landscape) orientation, the first and third pixels 1, 3 in each pixel group are used to provide a first image of an auto-stereoscopic image to the right eye of a viewer. The second and fourth pixels 2, 4 in each pixel group are used to provide a second image of the auto-stereoscopic image to the left eye of the viewer.

In the FIG. 18A example, the optical element 21v overlies the green sub-pixel 4b of the fourth pixel 4 and the optical element overlies the green sub-pixel 3b of the third pixel 3b. An optical barrier 104 extends from between the optical elements 21q and 21v to a position between the third and fourth pixels 3, 4.

The rays 140 and 142 in FIG. 18A illustrate the periphery of the field of vision of the right eye 60. The rays 140-142 have been extrapolated from the right eye 60 in FIG. 18A. It can be seen in FIG. 18A that the optical properties of the optical element 21v prevent ray 140 from meeting the green sub-pixel 4b of the fourth pixel 4. This means that the green sub-pixel 4b of the fourth pixel 4 is not visible to the right eye 60 of the viewer.

The ray 141 meets the green sub-pixel 3b of the third pixel 3. However, any light rays positioned between ray 140 and 141 would be prevented from meeting the sub-pixels 3b, 4b by the optical properties of the optical element 21v or the optical barrier 104. Consequently, the area 171 between the rays 140 and 141 can be considered to be a “dark area”.

The ray 142 meets the green sub-pixel 3b of the third pixel 3, indicating that it is visible to the right eye 60 of the viewer. The area 172 between the rays 141 and 142 represents the area through which light rays travel that enable the right eye 60 to see the green sub-pixel 3b of the third pixel 3.

The rays 143 and 145 in FIG. 18A illustrate the periphery of the field of vision of the left eye 61. The rays 143-145 have been extrapolated from the left eye 61 in FIG. 18A. It can be seen in FIG. 18A that the optical properties of the optical element 21q prevent ray 145 from meeting the green sub-pixel 3b of the third pixel 3. This means that the green sub-pixel 3b of the third pixel 3 is not visible to the left eye 61 of the viewer.

The ray 144 meets the green sub-pixel 4b of the fourth pixel 4. However, any light rays positioned between ray 144 and 145 would be prevented from meeting the sub-pixels 3b, 4b by the optical properties of the optical element 21q or the optical barrier 104. Consequently, the area 174 between the rays 144 and 145 can be considered to be a “dark area”.

The ray 143, however, meets the green sub-pixel 4b of the fourth pixel 4, indicating that it is visible to the left eye 61 of the viewer. The area 173 between the rays 143 and 144 represents the area through which light rays travel that enable the left eye 61 to see the green sub-pixel 4b of the fourth pixel 4.

A plan view light ray diagram could be drawn for the first and second pixels 1, 2 in which the optical system would reflect that of FIG. 18A. However, such a diagram is omitted here for conciseness.

FIG. 18B illustrates a side view of the pixel group 19a and the optical arrangement 20c when the display panel 18 is in the second (portrait) orientation. FIG. 18B shows the viewer's left eye 61 viewing the sub-pixels 2a, 2b, 2c, 4a, 4b, 4c of the second and fourth pixels 2, 4. The optical elements 21w, 21v, 21x, overlie the blue, green and red sub-pixels 4a, 4b, 4c of the fourth pixel 4 respectively. The optical elements 21y, 21z and 21n overlie the blue, green and red sub-pixels 2a, 2b, 2c of the second pixel 2 respectively.

A first optical barrier 105a extends from a position between the optical elements 21w and 21v and optically divides the blue sub-pixel 4a from the green sub-pixel 4b. A second optical barrier 105b extends from a position between the optical elements 21v and 21x and optically divides the green sub-pixel 4b from the red sub-pixel 4c.

A third optical barrier 105c extends from a position between the optical elements 21x and 21y and divides the fourth pixel 4 from the second pixel 2. A fourth optical barrier 105d extends from a position between the optical elements 21y and 21z and optically divides the blue sub-pixel 2a from the green sub-pixel 2b. A fifth optical barrier 105e extends from a position between the optical elements 21z and 21n and divides the green sub-pixel 2b from the red sub-pixel 2c.

The optical elements 21w, 21v, 21x, 21y, 21z and 21n direct light from the second and fourth pixels 2, 4 to enable them to be viewed by the viewer's left eye 61.

FIG. 18B illustrates a plurality of bundles of rays 200 to 207 that have been extrapolated from the viewer's left eye 61 to the display panel 18. The rays 200 and 207 indicate the periphery of the field of vision of the left eye 61 in the x-z plane.

FIG. 18C illustrates a magnified portion of FIG. 18C. In FIG. 18C, it can be seen that the bundles of rays labelled with the reference numerals 201, 202, 205 and 205 comprise two separate rays. The rays labelled 200 and 201a meet the blue sub-pixel 4a of the fourth pixel 4, indicating that this is visible to the left eye 61. The rays labelled 201b and 202a meet the green sub-pixel 4b of the fourth pixel 4, indicating that this is visible to the left eye 61. The rays labelled 202b and 203 meet the red sub-pixel 4c of the fourth pixel 4, indicating that this is visible to the left eye 61.

The rays labelled 204 and 205a meet the blue sub-pixel 2a of the second pixel 2, indicating that this is visible to the left eye 61. The rays labelled 205b and 206a meet the green sub-pixel 2b of the second pixel 2, indicating that this is visible to the left eye 61. The rays labelled 206b and 207 meet the red sub-pixel 2c of the second pixel 2.

Similar diagrams to FIGS. 18B and 18C could be drawn in illustrating the viewer's right eye 60 viewing the first and third pixels 1, 3. The optical system would reflect that illustrated in FIGS. 18B and 18C However, such diagrams are omitted for conciseness. FIG. 18D illustrates the areas 210a-210f, 211a-211f of the pixel group 19a that are visible to the viewer, when the display panel is in the second (landscape) orientation. The areas 210a-210c indicate the areas of the blue 3a, green 3b and red 3c sub-pixels that are visible to the right eye 60 of the viewer. The areas 210d-210f indicate the areas of the blue 1a, green 1b and red 1c sub-pixels that are visible to the right eye 60 of the viewer. The areas 211a-211c indicate the areas of the blue 4a, green 4b and red 4c sub-pixels that are visible to the left eye 61 of the viewer. The areas 211d-211f indicate the areas of the blue 2a, green 2b and red 2c sub-pixels that are visible to the left eye 61 of the viewer.

As mentioned above, when the display panel 18 is in the second (landscape) orientation, the first and third pixels 1, 3 in a pixel group 19a are the same colour and the second and fourth pixels 2, 4 are the same colour. The proximity of the sub-pixels in each pixel means that the viewer sees an overall colour of single pixel, rather than the individual colour of the individual sub-pixels.

The colour provided by the visible areas 210a to 210f causes the viewer's right eye 60 to perceive the optical elements overlying the first and third pixels 1, 3 to be coloured with the same colour as the overall colour provided by those areas 210a-210f. The optical elements overlying the first and third pixels 1, 3 effectively represents a single viewable pixel (having the same colour of the first and third pixels 1, 3) with respect to the image seen by the viewer's right eye 60.

The colour provided by the visible areas 211a to 211f causes the viewer's left eye 61 to perceive the optical elements overlying the second and fourth pixels 2, 4 to be coloured with the same colour as the overall colour provided by those areas 211a-211f. The optical elements overlying the second and fourth pixels 2, 4 effectively represents a single viewable pixel (having the same colour of the second and fourth pixels 2, 4) with respect to the image seen by the viewer's left eye 61.

FIG. 19 illustrates a Fresnel lens arrangement 212, 214, that is suitable for use in the third embodiment of the optical arrangement 20c. The reference numerals 212 and 214 indicates a plan view and a cross sectional view of the Fresnel lens arrangement respectively. Each optical element 213a-213l in the Fresnel lens arrangement overlies a sub-pixel of a pixel.

References to ‘computer-readable storage medium’, ‘computer program product’, ‘tangibly embodied computer program’ etc. or a ‘controller’, ‘computer’, ‘processor’, ‘processing circuitry’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The blocks illustrated in FIG. 8 may represent steps in a method and/or sections of code in the computer program 13. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, each pixel in the display panel 18 may have a different number of sub-pixels to that described above. For example, it may have a yellow sub-pixel in addition to red, green and blue sub-pixels.

In the embodiments of the invention described above, each pixel group comprises a 2×2 array of pixels. Each of those pixels comprises a plurality of sub-pixels.

In some embodiments of the invention, each of the pixels in the 2×2 array may comprise a plurality of smaller pixels. For example, each pixel may comprise a 2×2 array of smaller pixels. Each of those smaller pixels may comprise a plurality of sub-pixels (for example, red, green and blue sub-pixels). When controlling the display panel 18 to display an auto-stereoscopic image, the processing circuitry 12 may control each of the smaller pixels such that each of the smaller pixels in a pixel displays the same colour.

A switchable display apparatus which comprises the second embodiment of the optical arrangement 20b is described in relation to FIG. 15. However, it will apparent to those skilled in the art that other implementations of the switchable display apparatus may alternatively comprise the first embodiment of the optical arrangement 20a (a single optical element per pixel group) or the third embodiment of the optical arrangement (a single optical element sub-pixel in a pixel group). In such implementations, each optical element is a holographic optical element.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus, comprising:
a display panel comprising a plurality of pixel groups, wherein each pixel group comprises first, second, third and fourth pixels; and
an optical arrangement configured, when the display panel is in a first orientation relative to a viewer, to use the first and second pixels in each pixel group to provide a first image of an auto-stereoscopic image and to use the third and fourth pixels in each pixel group to provide a second image of the auto-stereoscopic image, and
wherein the optical arrangement is configured, when the display panel is in a second orientation relative to the viewer, to use the first and third pixels in each pixel group to provide a first image of a further auto-stereoscopic image and to use the second and fourth pixels in each pixel group to provide a second image of the further auto-stereoscopic image.

2. An apparatus as claimed in claim 1, wherein, when the display panel is in the first orientation, the first image of the auto-stereoscopic image is viewable by a first eye of a viewer without simultaneously viewing the second image of the auto-stereoscopic image, and the second image of the auto-stereoscopic image is viewable by the second eye of the viewer without simultaneously viewing the first image of the auto-stereoscopic image.

3. An apparatus as claimed in claim 2, wherein, when the display panel is in the second orientation, the first image of the further auto-stereoscopic image is viewable by the first eye of the viewer without simultaneously viewing the second image of the further auto-stereoscopic image, and the second image of the further auto-stereoscopic image is viewable by the second eye of the viewer without simultaneously viewing the first image of the further auto-stereoscopic image.

4. An apparatus as claimed in claim 1, wherein when the display panel is in the first orientation, the first pixel in each pixel group is positioned above the second pixel and the third pixel in each pixel group is positioned above the fourth pixel, and when the display panel is in the second orientation, the third pixel in each pixel group is positioned above the first pixel and the fourth pixel in each pixel group is positioned above the second pixel.

5. (canceled)

6. An apparatus as claimed in claim 1, wherein the first, second, third and fourth pixels in each pixel group are arranged in a 2×2 array.

7. An apparatus as claimed in claim 1, further comprising processing circuitry configured to control the display panel.

8. An apparatus as claimed in claim 7, wherein the processing circuitry is configured, when the display panel is in the first orientation, to control the first pixel in each pixel group to display the same colour as the second pixel in its pixel group, and to control the third pixel in each pixel group to display the same colour as the fourth pixel in its pixel group.

9. (canceled)

10. An apparatus as claimed in claim 7, wherein the processing circuitry is configured, when the display panel is the second orientation, to control the first pixel in each pixel group to display the same colour as the third pixel in its pixel group, and when the display panel is in the second orientation, to control the second pixel in each pixel group to display the same colour as the fourth pixel in its pixel group.

11. (canceled)

12. An apparatus as claimed in claim 1, wherein, in the second orientation, the display panel is rotated by approximately 90 degrees relative to the first orientation.

13. (canceled)

14. An apparatus as claimed in claim 1, wherein the optical arrangement comprises an array of optical elements, overlying the display panel, configured to provide the auto-stereoscopic image and the stereoscopic image.

15.-20. (canceled)

21. An apparatus as claimed in claim 14, wherein the optical elements are provided by at least one holographic optical device.

22. (canceled)

23. An apparatus, comprising:
a housing;
at least one memory storing a computer program comprising computer program instructions; and
at least one processor configured to execute the computer program instructions to cause the apparatus at least to perform:
controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and
controlling, when the display panel is in a second orientation, the first and third pixels in each pixel group to display a first image of a further auto-stereoscopic image and the second and fourth pixels in each pixel group to display a second image of the further auto-stereoscopic image.

24. An apparatus as claimed in claim 23, wherein the at least one processor is configured, in response to determining that the orientation of the display panel has changed from the first orientation to the second orientation, to change from i) controlling the first and second pixels in each pixel group of the display panel to display the first image of the auto-stereoscopic image and the third and fourth pixels in each pixel group of the display panel to display the second image of the auto-stereoscopic image, to ii) controlling the first and third pixels in each pixel group to display the first image of the further auto-stereoscopic image and the second and fourth pixels in each pixel group to display the second image of the auto-stereoscopic image.

25. An apparatus as claimed in claim 23, wherein when the display panel is in the first orientation, the first pixel in each pixel group is positioned above the second pixel and the third pixel in each pixel group is positioned above the fourth pixel, and when the display panel is in the second orientation, the third pixel in each pixel group is positioned above the first pixel and the fourth pixel in each pixel group is positioned above the second pixel.

27. (canceled)

28. An apparatus as claimed in claim 23, wherein the at least one processor is configured, when the display panel is in the first orientation, to control the first pixel in each pixel group to display the same colour as the second pixel in its pixel group, and to control the third pixel in each pixel group to display the same colour as the fourth pixel in its pixel group.

29. (canceled)

30. An apparatus as claimed in claim 23, wherein the at least one processor is configured, when the display panel is the second orientation, to control the first pixel in each pixel group to display the same colour as the third pixel in its pixel group, and to control the second pixel in each pixel group to display the same colour as the fourth pixel in its pixel group.

31.-33. (canceled)

34. A method, comprising:
controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and
controlling, when the display panel is in a second orientation, the first and third pixels in each pixel group to display a first image of a further auto-stereoscopic image and the second and fourth pixels in each pixel group to display a second image of the further auto-stereoscopic image.

35. A method as claimed in claim 34, wherein when the display panel is in the first orientation, the first pixel in each pixel group is positioned above the second pixel and the third pixel in each pixel group is positioned above the fourth pixel.

36. A method as claimed in claim 34 wherein when the display panel is in the second orientation, the third pixel in each pixel group is positioned above the first pixel and the fourth pixel in each pixel group is positioned above the second pixel.

37.-45. (canceled)

46. A computer program comprising computer program instructions that, when executed by at least one processor, cause at least the following to be performed:
controlling, when a display panel is in a first orientation, first and second pixels in each pixel group of the display panel to display a first image of an auto-stereoscopic image and the third and fourth pixels in each pixel group of the display panel to display a second image of the auto-stereoscopic image, wherein the display panel comprises a plurality of pixel groups and each pixel group comprises first, second, third and fourth pixels; and
controlling, when the display panel is in a second orientation, the first and third pixels in each pixel group to display a first image of a further auto-stereoscopic image and the second and fourth pixels in each pixel group to display a second image of the further auto-stereoscopic image.

47.-57. (canceled)
